(19) United States
(12) Patent Application Publication
(10) Pub. No.: US 2024/0104927 A1
(43) Pub. Date: Mar. 28, 2024

(54) CONTROL DEVICE AND CONTROL METHOD

(71) Applicant: SONY GROUP CORPORATION, TOKYO (JP)

(72) Inventor: SHINGO TSURUMI, TOKYO (JP)

(21) Appl. No.: 18/251,544

(22) PCT Filed: Nov. 4, 2021
(86) PCT No.: PCT/JP2021/040518

§ 371 Date: May 3, 2023

(30) Foreign Application Priority Data
Nov. 11, 2020 (JP) 2020-188135

(51) Int. Cl. G06V 20/40; B25J 9/16; G06V 20/58; G06V 40/20

(52) U.S. Cl. CPC G06V 20/42; B25J 9/1664; G06V 20/58; G06V 40/23

(57) ABSTRACT

A control device (120) includes a first recognition unit (1209, 1211), a second recognition unit (1213), a third recognition unit (1215), and a planning unit (1216). The first recognition unit (1209, 1211) recognizes a state of an imaging target of a mobile body based on information acquired by a sensor. The second recognition unit (1213) recognizes a surrounding environment of the mobile body based on information acquired by the sensor. The third recognition unit (1215) recognizes a situation in which an imaging target is placed based on a recognition result of a state of the imaging target, a recognition result of a surrounding environment, and imaging environment information regarding an imaging environment in which the imaging target is imaged. The planning unit (1216) determines an action plan of the mobile body for executing video recording of the imaging target based on a situation recognition result, indicating the recognition result of the situation in which the imaging target is placed and based on setting information predefined for each type of sport for determining the operation of the mobile body.

### FIELD

The present disclosure relates to a control device and a control method.

### BACKGROUND

In recent years, unmanned aerial vehicles equipped with a function of tracking and performing continuous automatic capture of an object while avoiding an obstacle have been commercialized.

In addition, automatic capture of a sliding scene of skiing or snowboarding, a scene of trekking using an off-road bicycle, and the like is also performed using the above-described unmanned aerial vehicle.

### CITATION LIST

### Non Patent Literature

Non Patent Literature 1: “MAVIC 2: See the bigger picture”, [searched on Sep. 1, 2020], Internet <URL:https://www.dji.com/jp/mavic2>

### SUMMARY

### Technical Problem

However, in a case where a scene of a sport is captured using the above-described unmanned aerial vehicle, there is a problem of difficulty in successfully performing constant recording of appropriate information corresponding to the type of sport.

In view of this, the present disclosure proposes a control device and a control method capable of recording appropriate information corresponding to the type of sport.

### Solution to Problem

To solve the above problem, a control device that provides a service that requires an identity verification process according to an embodiment of the present disclosure includes: a first recognition unit that recognizes a state of an imaging target of a mobile body based on information acquired by a sensor; a second recognition unit that recognizes a surrounding environment of the mobile body based on information acquired by the sensor; a third recognition unit that recognizes a current situation in preparation for imaging of the imaging target based on a recognition result of the state of the imaging target obtained by the first recognition unit, a recognition result of the surrounding environment obtained by the second recognition unit, and imaging environment information regarding an imaging environment in which the imaging of the imaging target is performed; and a planning unit that determines an action plan of the mobile body for executing video recording of the imaging target based on a situation recognition result indicating the recognition result of the current situation in preparation for imaging of the imaging target obtained by the third recognition unit and based on setting information predefined for each type of sport for determining an operation of the mobile body.

### BRIEF DESCRIPTION OF DRAWINGS

FIG. 1 is a schematic diagram illustrating an outline of information processing according to an embodiment of the present disclosure.

FIG. 2 is a diagram illustrating an outline of setting information according to the embodiment of the present disclosure.

FIG. 3 is a diagram illustrating an outline of a situation recognition result according to the embodiment of the present disclosure.

FIG. 4 is a diagram illustrating a specific example of a situation recognition result according to the embodiment of the present disclosure.

FIG. 5 is a schematic diagram illustrating an outline of information processing according to the embodiment of the present disclosure.

FIG. 6 is a diagram illustrating an outline of setting information according to the embodiment of the present disclosure.

FIG. 7 is a diagram illustrating a specific example of a situation recognition result according to the embodiment of the present disclosure.

FIG. 8 is a schematic diagram illustrating a system configuration example according to the embodiment of the present disclosure.

FIG. 9 is a block diagram illustrating a configuration example of a mobile body according to the embodiment of the present disclosure.

FIG. 10 is a diagram illustrating an outline of an action policy according to the embodiment of the present disclosure.

FIG. 11 is a diagram illustrating a specific example of information acquired as a situation recognition result according to the embodiment of the present disclosure.

FIG. 12 is a diagram illustrating a specific example of information acquired as a situation recognition result according to the embodiment of the present disclosure.

FIG. 13 is a schematic diagram illustrating an outline of an imaging mode according to the embodiment of the present disclosure.

FIG. 14 is a schematic diagram illustrating an outline of an imaging mode according to the embodiment of the present disclosure.

FIG. 15 is a schematic diagram illustrating an outline of an imaging mode according to the embodiment of the present disclosure.

FIG. 16 is a schematic diagram illustrating an outline of an imaging mode according to the embodiment of the present disclosure.

FIG. 17 is a schematic diagram illustrating an outline of information provision according to the embodiment of the present disclosure.

FIG. 18 is a schematic diagram illustrating an outline of information provision according to the embodiment of the present disclosure.

FIG. 19 is a schematic diagram illustrating an outline of information provision according to the embodiment of the present disclosure.

FIG. 20 is a schematic diagram illustrating an outline of information provision according to the embodiment of the present disclosure.

FIG. 21 is a diagram illustrating an outline of cooperative processing between mobile bodies according to the embodiment of the present disclosure.

FIG. 22 is a diagram illustrating an outline of cooperative processing between mobile bodies according to the embodiment of the present disclosure.

FIG. 23 is a diagram illustrating an outline of a cooperative processing between the mobile body and a wearable device according to the embodiment of the present disclosure.

FIG. 24 is a schematic diagram illustrating an outline of imaging from a structure according to the embodiment of the present disclosure.

FIG. 25 is a diagram illustrating an example of a landing gear of a mobile body according to the embodiment of the present disclosure.

FIG. 26 is a view illustrating a state in which the landing gear of the mobile body according to the embodiment of the present disclosure is attached to the structure.

FIG. 27 is a block diagram illustrating a configuration example of a terminal device according to the embodiment of the present disclosure.

FIG. 28 is a flowchart illustrating an overall processing procedure example of a control device according to the embodiment of the present disclosure.

FIG. 29 is a flowchart illustrating a processing procedure example of action control processing of the control device according to the embodiment of the present disclosure.

FIG. 30 is a flowchart illustrating a specific processing procedure example (1) of the action control processing of the control device according to the embodiment of the present disclosure.

FIG. 31 is a flowchart illustrating a specific processing procedure example (2) of the action control processing of the control device according to the embodiment of the present disclosure.

FIG. 32 is a block diagram illustrating a device configuration example according to a modification.

FIG. 33 is a schematic diagram illustrating a system configuration example according to a modification.

FIG. 34 is a block diagram illustrating a device configuration example according to a modification.

FIG. 35 is a schematic diagram illustrating a system configuration example according to a modification.

FIG. 36 is a block diagram illustrating a device configuration example according to a modification.

FIG. 37 is a diagram illustrating an example of player information according to a modification.

FIG. 38 is a diagram illustrating an example of imaging environment information according to a modification.

FIG. 39 is a block diagram illustrating a hardware configuration example of a computer capable of implementing the control device according to the embodiment of the present disclosure.

### DESCRIPTION OF EMBODIMENTS

Embodiments of the present disclosure will be described below in detail with reference to the drawings. In each of the following embodiments, the same parts are denoted by the same numbers or reference signs, and a repetitive description thereof will be omitted in some cases. Moreover, in the present specification and the drawings, a plurality of components having substantially the same functional configuration will be distinguished by attaching different numbers or reference signs after the same numbers or reference signs.

The present disclosure will be described in the following order.
1. Overview of information processing according to embodiment of present disclosure
2. System configuration example
3. Device configuration example
4. Processing procedure example
5. Modifications
6. Others
7. Hardware configuration example
8. Conclusion

### 1. Overview of Information Processing According to Embodiment of Present Disclosure

(1-1. Video Recording in Golf)

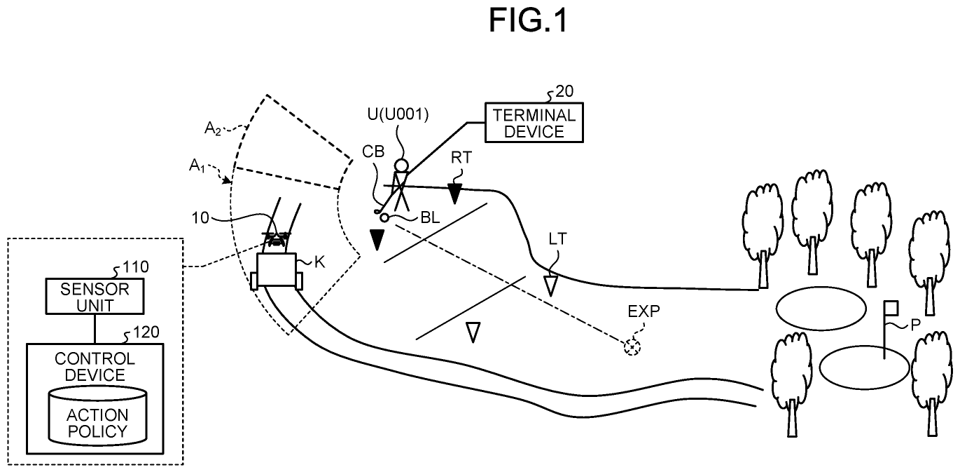

An outline of information processing according to an embodiment of the present disclosure will be described. FIG. 1 is a schematic diagram illustrating an outline of information processing according to the embodiment of the present disclosure. Hereinafter, an example of executing video recording of a user playing golf will be described.

A mobile body 10 illustrated in FIG. 1 is an unmanned aerial vehicle capable of flying by remote control or automatic control. The mobile body 10 may be referred to as a drone or a multi-copter. The mobile body 10 executes video recording of various sports and the like while moving autonomously.

A terminal device 20 illustrated in FIG. 1 is a communication device possessed by a player U, and is typically a wearable terminal such as a smartphone, a tablet, or a smart watch.

As illustrated in FIG. 1, the mobile body 10 includes a sensor unit 110 and a control device 120. The sensor unit 110 includes various sensors that acquire information for autonomous movement, information for recognizing a state of an imaging target, and information for recognizing a surrounding environment of the mobile body 10, for example. The control device 120 controls individual portions of the mobile body 10, and implements video recording of an imaging target by the mobile body 10 and provision of advice from the mobile body 10 regarding the imaging target.

The control device 120 recognizes the state of the imaging target of the mobile body 10 based on information acquired by the various sensors included in the sensor unit 110.

Furthermore, the control device 120 recognizes the surrounding environment of the mobile body 10 based on information acquired by the various sensors included in the sensor unit 110. Specifically, the control device 120 creates an environmental map indicating the surrounding environment of the mobile body 10 based on the position, attitude, distance information, and the like, regarding the mobile body 10. The environmental map includes a position of an imaging target around the mobile body 10, a position of an obstacle, and the like.

Subsequently, the control device 120 recognizes the current situation in preparation for imaging of the imaging target based on the recognition result of the state of the imaging target of the mobile body 10, the recognition result of the surrounding environment of the mobile body 10, and the imaging environment information regarding the imaging environment in which the imaging of the imaging target of the mobile body 10 is performed.

Subsequently, the control device 120 determines an action plan of the mobile body 10 based on the situation recognition result indicating the recognition result of the current situation in preparation for the imaging of the imaging target and based on the setting information predefined for each type of sport in order to determine the operation of the mobile body 10.

In the case illustrated in FIG. 1, the imaging target corresponds to an object such as the player U playing golf, a golf ball BL and a golf club CB used by the player U. Furthermore, in the case illustrated in FIG. 1, the state of the imaging target includes the state of the player U. The control device 120 recognizes the position, orientation, posture, motion, and the like of the player U. The control device 120 can specifically recognize the motion and the state (situation) of the player U, such as whether the state is before the shot or after the shot, whether the shot is a tee shot, a bunker shot, putting, a penalty such as out of bounds (OB) and water hazard shot, the uphill shot, the downhill shot, an air shot, or the player is during the practice swing, as well as the width of the stance (address) and the selected club.

In addition, the state of the imaging target includes states of the golf ball BL, the golf club CB, and the like. The control device 120 recognizes positions, speeds, motions, and the like of the golf ball BL and the golf club CB. The control device 120 may specifically recognize whether the golf ball BL is located in a bunker, in a rough, on a green, or in a penalty area, a situation of the lie of the golf ball BL, and the like. The control device 120 can also specifically recognize the relative positional relationship between the player U and the golf ball BL.

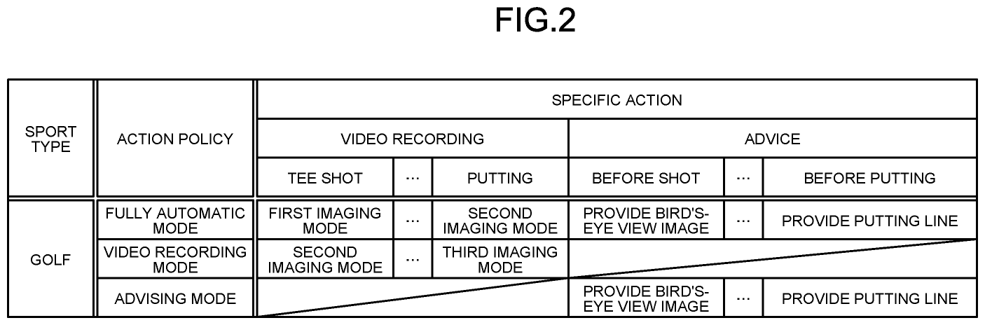

FIG. 2 is a diagram illustrating an outline of setting information according to the embodiment of the present disclosure. FIG. 2 illustrates an example of the configuration of the setting information, and may be appropriately changed as necessary, not particularly limited to the example illustrated in FIG. 2. The setting information is flexibly set by the user of the mobile body 10.

As illustrated in FIG. 2, the setting information is constituted by associating an item of “sport type”, an item of “action policy”, and an item of “specific action” with each other.

Information set in the item “type of sport” includes information specifying the type of sport such as golf, for example.

Information set in the item “action policy” includes information designating the specific action (action) of the mobile body 10. Examples of the action policy of the mobile body 10 to be implemented include a fully automatic mode, a video recording mode, and an advising mode. In the example illustrated in FIG. 2, for convenience of explanation, the name of the action policy is indicated as the information designating the action policy. Alternatively, any information may be used as long as the control device 120 can specify the action policy by the information.

The fully automatic mode is an operation mode for causing the mobile body 10 to execute video recording of a player or the like as an imaging target and provision of advice or the like to the player. The video recording mode is an operation mode for causing the mobile body 10 to execute video recording of a player or the like as an imaging target. The advising mode is an operation mode for causing the mobile body 10 to execute provision of advice to the player.

Information set in the item of “specific action” includes information regarding specific action of the mobile body 10 corresponding to the information set in the item of “sport type” and the item of “action policy”. The item of “specific action” is divided into an item of “video recording” and an item of “advice”. Information set in an item of “video recording” includes an imaging mode used to capture an image of a moment of a shot. Information set in the item of “advice” includes details of information to be provided to the player at every predetermined timing.

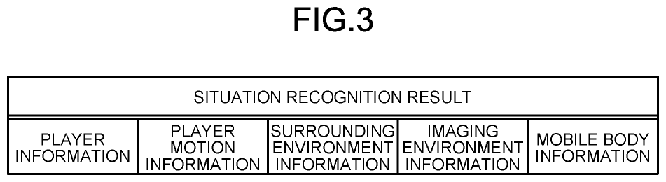

The control device 120 selects the specific action to be executed by the mobile body 10 from the above-described setting information based on the type of sport and the action policy. Then, in order to control the mobile body 10 to operate based on the selected specific action, the control device 120 determines an action plan reflecting a situation recognition result regarding a recognition result indicating a recognition result of a current situation in preparation for the imaging of the imaging target. FIG. 3 is a diagram illustrating an outline of a situation recognition result according to the embodiment of the present disclosure.

As illustrated in FIG. 3, the information acquired as the situation recognition result obtained by the control device 120 includes information such as player information, player motion information, surrounding environment information, imaging environment information, mobile body information.

The player information is information unique to a golf player. Examples of the information includes information indicating whether the player is right handed or left handed and average distance information for each club.

The player motion information is information indicating a motion details of a golf player. Examples of the information include information regarding a teeing ground used by the player as an imaging target, information regarding a selected club, and address (stance) width information.

The surrounding environment information is information regarding the surrounding environment recognized by the mobile body 10, and examples thereof include information regarding the wind direction on the golf course, passage position information, and cart position information.

The imaging environment information is information regarding the imaging environment of the mobile body 10, and examples thereof include information regarding a course form such as a dogleg, information regarding unevenness of a course such as a downhill and uphill courses, information regarding the position of a pin P, information regarding the position of an obstacle such as a bunker or a creek, and information regarding the position of the teeing area.

The mobile body information is information related to the mobile body 10, and examples thereof include information regarding the level of remaining power, which is a power source of the mobile body 10, and version information of an application program executed in the mobile body 10.

The control device 120 determines an action plan of the mobile body 10 based on the above-described situation recognition result and the above-described setting information. Hereinafter, determination of the action plan by the control device 120 will be sequentially described.

First, the control device 120 preliminarily connects the mobile body 10 and the terminal device 20 so as to be communicable with each other. The control device 120 issues user ID unique to the player U at the time of connecting the mobile body 10 and the terminal device 20 to each other. The user ID is associated with the recorded image information.

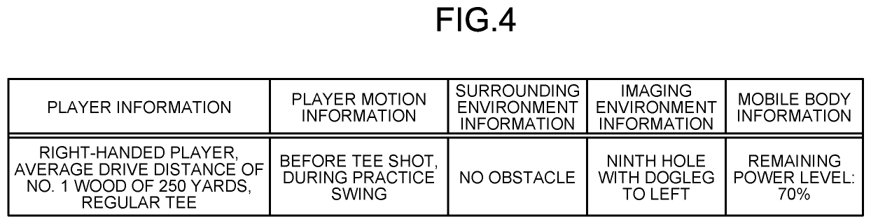

The control device 120 acquires information of a sport type, player information, and action policy from the terminal device 20 in connection. With reference to the setting information, the control device 120 selects a specific action corresponding to the information regarding the sport type and the action policy acquired from the terminal device 20. Subsequently, the control device 120 determines the action plan based on the situation recognition result, which represents the recognition result of the current situation in preparation for the imaging of the player U. FIG. 4 is a diagram illustrating a specific example of a situation recognition result according to the embodiment of the present disclosure. FIG. 4 illustrates an example of a situation recognition result corresponding to golf.

In the example illustrated in FIG. 4, the control device 120 acquires the situation recognition result on the player U, specifically, player information, player motion information, surrounding environment information, imaging environment information, and mobile body information. From the situation recognition result illustrated in FIG. 4, the control device 120 grasps a specific situation in which, specifically, the player U, being a right handed player and using the regular tee with an average drive distance of the No. 1 wood of 250 yards, is performing practice swing before the tee shot in the ninth hole with a dogleg to the left. In addition, the control device 120 also recognizes that there is no obstacle around the mobile body 10 and that the remaining power level of the mobile body 10 is 70%.

In order to control the mobile body 10 to operate based on the specific action selected from the setting information, the control device 120 determines an action plan reflecting the situation recognition result of the player U described above. For example, the control device 120 selects “video recording” as an action based on the action policy designated by the player U, and selects “first imaging mode” as the imaging mode according to the situation recognition result (prior to tee shot) of the player U.

Subsequently, the control device 120 determines a camera angle for imaging the moment of the tee shot in the selected first imaging mode. The control device 120 searches for an imaging position (for example, an imaging position A₁) at which the moment of the tee shot can be imaged in a composition predetermined in the first imaging mode, and then determines the angle of the camera. In addition, the control device 120 may calculate the predicted falling point of the ball hit by the player U and add the result when determining the camera angle.

After determining the camera angle, the control device 120 determines an action plan for causing the mobile body 10 to image the moment of the tee shot. For example, the control device 120 determines a movement plan for moving the mobile body 10 from a cart K to the imaging position A₁ based on the positional relationship between the player U and the golf ball BL on the environmental map, the position and attitude of the mobile body on the environmental map, and the like. Subsequently, the control device 120 determines an action plan of the mobile body 10, specifically, a plan to move along a movement route based on the movement plan from the cart K to the imaging position A₁ to image the moment of the tee shot.

Furthermore, when having specified, in determining the camera angle, that a course of the player U for the tee shot is a downhill course from the imaging environment information, the control device 120 can determine the camera angle reflecting that the shot will be a downhill tee shot. For example, the control device 120 determines an imaging position (for example, an imaging position A₂) and a camera angle at which the moment of the tee shot can be imaged in a composition predetermined in the first imaging mode.

Furthermore, when having specified, in determining the camera angle, that the remaining power level of the mobile body 10 is a predetermined threshold or less from the mobile body information, the control device 120 can determine the camera angle reflecting that the remaining power level of the mobile body 10 is the threshold or less. For example, the control device 120 images the moment of a tee shot without moving from the cart K. At this time, in a case where it is difficult to capture an image in a predetermined composition in the first imaging mode, another composition capable of capturing the moment of the tee shot of the player U from the cart is automatically set, and the angle of the camera is determined.

(1-2. Video Recording of Climbing)

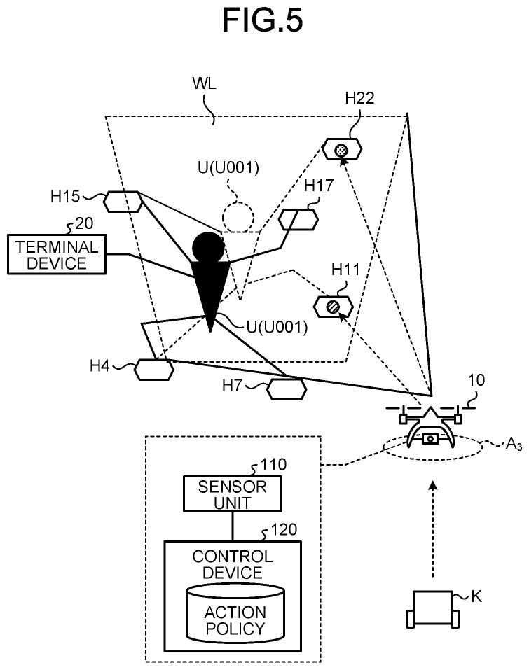

The following will describe, as an outline of information processing of the present disclosure, an example in which the control device 120 executes video recording or the like of a user who performs climbing while controlling individual units of the mobile body 10. FIG. 5 is a schematic diagram illustrating an outline of information processing according to the embodiment of the present disclosure.

In the case illustrated in FIG. 5, examples of imaging targets include a player U who is climbing, a wall WL used by the player U, and a plurality of holds H provided on the wall WL. In the case illustrated in FIG. 5, examples of the states of the imaging targets include the state of the player U as well as the states of the wall WL and the hold H used by the player U.

Furthermore, in the case illustrated in FIG. 5, the control device 120 recognizes a state such as the position, orientation, posture motion of the player U, as the state of the player U. The control device 120 recognizes the state such as the position and angle of the wall WL, the position and size of the hold H, and the position of the goal, as the states of the wall WL and the hold H. Subsequently, based on the recognition result of the state of the player U and the recognition result of the states of the wall WL and the hold H, the control device 120 specifically recognizes a positional relationship between the player U and the wall WL and the hold H.

Furthermore, in the case illustrated in FIG. 5, the imaging environment information being information regarding the imaging environment corresponds to information about a facility (venue) where climbing is performed. In the case illustrated in FIG. 5, the current situation in preparation for the imaging of the imaging target includes the situation of the player U during climbing. The situation of the player U includes a position and a posture of the player U during climbing, a position of a hand or a foot of the player U, and the like. Furthermore, the current situation in preparation for the imaging of the imaging target includes the state such as the position of the goal, the positional relationship between the player U and the hold H, and the positional relationship between the player U and the goal.

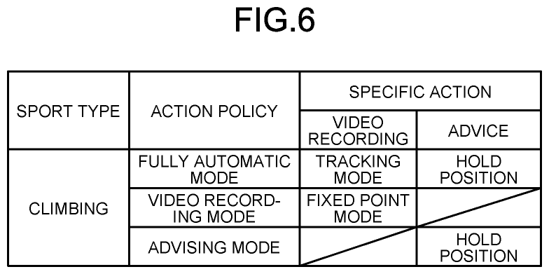

In the case illustrated in FIG. 5, the control device 120 acquires sport type information, player information, and action policy information from the connected terminal device 20. With reference to the setting information, the control device 120 selects a specific action corresponding to the information regarding the sport type and the action policy acquired from the terminal device 20. FIG. 6 is a diagram illustrating an outline of setting information according to the embodiment of the present disclosure. FIG. 6 illustrates an outline of setting information corresponding to climbing.

The setting information corresponding to climbing illustrated in FIG. 6 includes setting of specific action corresponding to each action policy. Information set in an item of “video recording” corresponding to “fully automatic mode” is “tracking mode”. The “tracking mode” is an imaging mode of capturing an image while tracking the state of the player. Information set in an item of “video recording” corresponding to “video recording mode” is “fixed point mode”. The “fixed point mode” is an imaging mode of imaging the state of the player from a fixed point. Information set in an item of “advice” corresponding to the “fully automatic mode” and the “advising mode” is “hold position”. The “hold position” indicates that a hole position to move to next is presented to the player who is climbing.

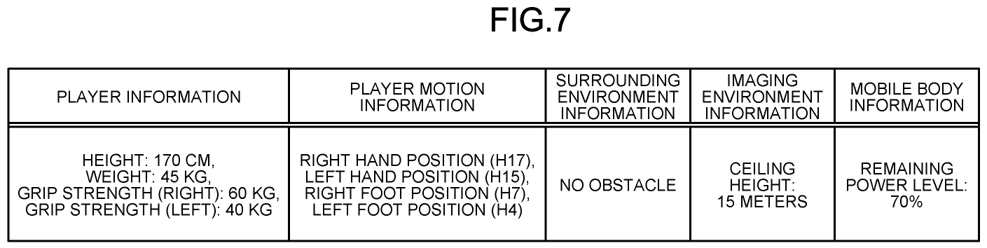

Subsequently, the control device 120 determines the action plan based on the situation recognition result, which represents the recognition result of the current situation in preparation for the imaging of the player U. FIG. 7 is a diagram illustrating a specific example of a situation recognition result according to the embodiment of the present disclosure. FIG. 7 illustrates an example of a situation recognition result corresponding to climbing.

As illustrated in FIG. 7, the control device 120 acquires the player information, the player motion information, and the imaging environment information, as the situation recognition result of the player U. From the situation recognition result illustrated in FIG. 7, the control device 120 grasps a specific situation in which the player U is 170 cm in height, 45 kilograms in weight, 60 kilograms in grip strength of the right hand, and 40 kilograms in grip strength of the left hand, and the player U has its right hand positioned at a “hold (H17)”, its left hand at a “hold (H15)”, its right foot at a “hold (H7)”, and its left foot at a “hole (H4)”. In addition, the control device 120 also recognizes that there is no obstacle around the mobile body 10, that the height of the ceiling is 15 meters, and that the remaining power level of the mobile body 10 is 70%.

Subsequently, in order to control the mobile body 10 to operate based on the specific action selected from the setting information, the control device 120 determines an action plan reflecting the situation recognition result of the player U described above. For example, the control device 120 selects “video recording” as an action based on the action policy designated by the player U, and selects the tracking mode as the imaging mode.

For example, when the action policy designated by the player U is the “fully automatic mode”, the control device 120 selects the “tracking mode” as the imaging mode to be used for video recording. The control device 120 then determines a camera angle for imaging the state of the player climbing in the tracking mode. For example, while tracking the player U who is climbing, the control device 120 appropriately searches for an imaging position where the state of the player U who is climbing can be imaged in a predetermined composition in the tracking mode, and determines the angle of the camera at the searched imaging position at every time of search.

After determining the camera angle, the control device 120 images the state of climbing and determines an action plan for causing the mobile body 10 to execute an operation of providing advice. For example, the control device 120 determines the optimal movement route for imaging the player U based on the positional relationship between the player U and the hold H, the positional relationship between the player U and the goal, the environmental map, and the like. Then, the control device 120 determines an action plan of the mobile body 10 to capture an image of the climbing state with a composition (for example, the rear side of the player U) predetermined in the tracking mode while tracking the player U using the determined movement route. In addition, the control device 120 determines an operation of presenting the position of the hold H (for example, holds H11 and H22) to move to next to the player U as a part of the action plan for causing the mobile body 10 to execute in parallel with the video recording of capturing the climbing state. For example, the advice on the hold H to move to next can be implemented by a method such as projection mapping for the hold H or sound notification to the terminal device 20 carried by the player U.

Furthermore, when the action policy designated by the player U is the “video recording mode”, the control device 120 selects the “fixed point mode” as the imaging mode to be used for video recording. The control device 120 then determines a camera angle for imaging the state of the player who is climbing in the fixed point mode. For example, the control device 120 searches for an imaging position (for example, an imaging position A₃) at which the state of the player U during climbing can be imaged in a composition predetermined in the fixed point mode, and determines the angle of the camera. The control device 120 then determines an action plan for imaging the state of climbing from a fixed point.

In this manner, the control device 120 can select the specific action to be executed by the mobile body 10 and determine the action plan of the mobile body 10 based on the situation recognition result indicating the recognition result of the current situation in preparation for the imaging of the imaging target and the action policy of the mobile body 10 predefined for each type of sport. This makes it possible to record appropriate information according to the request of the user. In addition, the control device 120 determines presentation of information useful for the player to proceed with a sport, as a part of the action plan. This makes it possible to improve the usability of the user who performs video recording and the like using the mobile body 10.

### 2. System Configuration Example

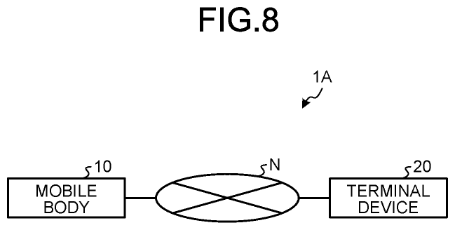

Hereinafter, a configuration example of an information processing system according to the embodiment of the present disclosure will be described. FIG. 8 is a schematic diagram illustrating a system configuration example according to the embodiment of the present disclosure. As illustrated in FIG. 8, an information processing system 1A according to the embodiment of the present disclosure includes a mobile body 10 and a terminal device 20. The configuration of the information processing system 1A is not particularly limited to the example illustrated in FIG. 6, and may include more mobile bodies 10 and terminal devices 20 than those illustrated in FIG. 8.

The mobile body 10 and the terminal device 20 are connected to a network N. The mobile body 10 communicates with the terminal device 20 via the network N. The terminal device 20 communicates with the mobile body 10 via the network N.

The mobile body 10 acquires information such as user ID, sport type information, operation mode information, and player information from the terminal device 20. The mobile body 10 transmits information to the terminal device 20. The information transmitted from the mobile body 10 to the terminal device 20 includes information useful for the player to proceed with a sport. Examples of the useful information in playing golf include a bird's-eye view image obtained by overlooking a positional relationship between a golf ball and a pin, and an image indicating situations of the golf ball.

The terminal device 20 transmits information such as the user ID, the sport type information, the player information, the operation mode information to the mobile body 10.

### 3. Device Configuration Example

(3-1. Configuration of Mobile Body)

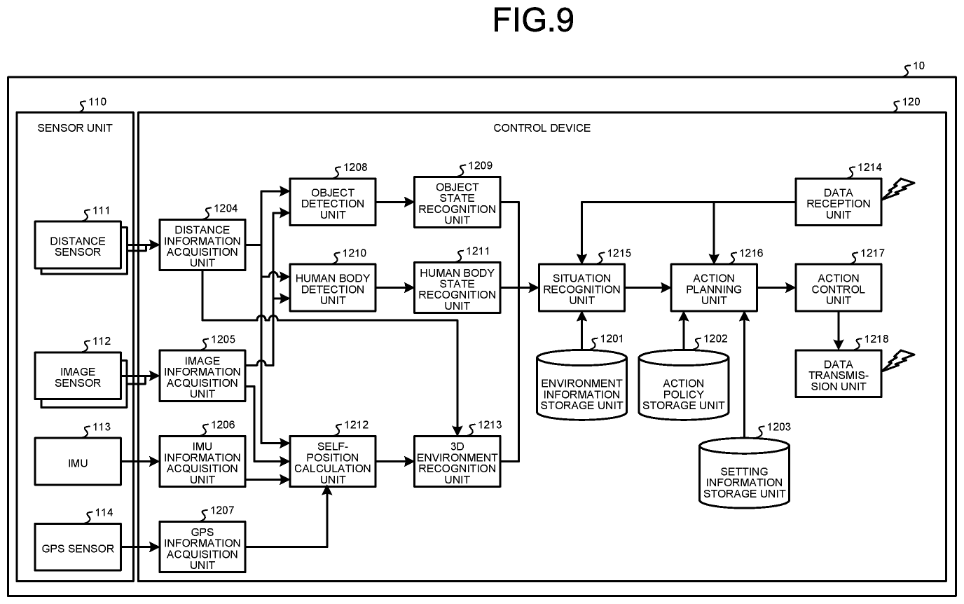

Hereinafter, a configuration example of the mobile body 10 will be described. FIG. 9 is a block diagram illustrating a configuration example of a mobile body according to the embodiment of the present disclosure. As illustrated in FIG. 9, the mobile body 10 includes a sensor unit 110 and a control device 120.

The sensor unit 110 includes a distance sensor 111, an image sensor 112, an inertial measurement unit (IMU) 113, and a global positioning system (GPS) sensor 114.

The distance sensor 111 measures a distance to an object around the mobile body 10 and acquires distance information. The distance sensor 111 can be implemented by a time of flight (ToF) sensor, laser imaging detection and ranging (LiDAR) or the like. The distance sensor 111 transmits the acquired distance information to the control device 120.

The image sensor 112 images an object around the mobile body 10 and acquires image information (image data of a still image or a moving image). The image information acquired by the image sensor 112 includes image information obtained by imaging the state of sports. This can be implemented by an image sensor such as a charge coupled device (CCD) image sensor and a complementary metal-oxide-semiconductor (CMOS) image sensor. The image sensor 112 transmits the acquired imaged data to the control device 120.

The IMU 113 detects an angle, acceleration, or the like of an axis indicating an operation state of the mobile body 10 and acquires IMU information. The IMU 113 can be implemented by various sensors such as an acceleration sensor, a gyro sensor, and a magnetic sensor. The IMU 113 transmits the acquired IMU information to the control device 120.

The GPS sensor 114 measures a position (latitude and longitude) of the mobile body 10 and acquires GPS information. The GPS sensor 114 transmits the acquired GPS information to the control device 120.

The control device 120 is a controller that controls individual units of the mobile body 10. The control device 120 can be implemented by a control circuit including a processor and memory. Each functional unit included in the control device 120 is implemented by executing a command described in a program read from internal memory by a processor using the internal memory as a work area, for example. The program read from the internal memory by the processor includes an operating system (OS) and an application program. In addition, each of the functional units included in the control device 120 may be implemented by an integrated circuit such as an application specific integrated circuit (ASIC) or a field-programmable gate array (FPGA).

Furthermore, a main storage device and an auxiliary storage device functioning as the internal memory described above are implemented by a semiconductor memory element such as random access memory (RAN) or flash memory, or a storage device such as a hard disk or an optical disk.

As illustrated in FIG. 7, the control device 120 includes an environment information storage unit 1201, an action policy storage unit 1202, and a setting information storage unit 1203 as functional units for implementing the information processing according to the embodiment of the present disclosure.

In addition, the control device 120 includes a distance information acquisition unit 1204, an image information acquisition unit 1205, an IMU information acquisition unit 1206, and a GPS information acquisition unit 1207 as the above-described functional units. Furthermore, the control device 120 includes an object detection unit 1208, an object state recognition unit 1209, a human body detection unit 1210, a human body state recognition unit 1211, a self-position calculation unit 1212, and a 3D environment recognition unit 1213 as the above-described functional units. The object state recognition unit 1209 and the human body state recognition unit 1211 function as a first recognition unit that recognizes the state of the imaging target of the mobile body 10 based on the information acquired by the sensor. The 3D environment recognition unit 1213 functions as a second recognition unit that recognizes surrounding environment of the mobile body 10 based on the information acquired by the sensor.

Furthermore, the control device 120 includes a data reception unit 1214, a situation recognition unit 1215, an action planning unit 1216, an action control unit 1217, and a data transmission unit 1218 as the above-described functional units. The situation recognition unit 1215 functions as a third recognition unit that recognizes the current situation in preparation for the imaging of the imaging target based on the recognition result of the state of the imaging target obtained by the first recognition unit, the recognition result of the surrounding environment obtained by the second recognition unit, and the imaging environment information regarding the imaging environment in which the imaging of the imaging target is performed. The action planning unit 1216 functions as a planning unit that determines an action plan of the mobile body 10 for executing video recording of the imaging target based on a situation recognition result indicating a recognition result of a current situation in preparation for imaging of the imaging target and setting information predefined for each type of sport for determining the operation of the mobile body 10.

The environment information storage unit 1201 stores imaging environment information regarding an imaging environment in which the imaging target is imaged. For example, in a case where imaging by the mobile body 10 is performed in a golf course, the environment information storage unit 1201 stores information such as a position of a pin, a position of a teeing area, and a course form, as the imaging environment information.

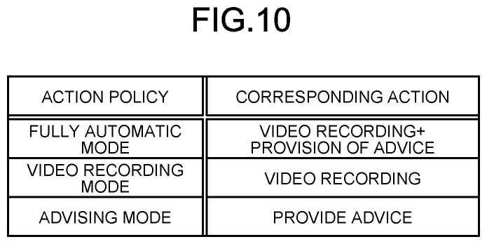

The action policy storage unit 1202 stores information regarding an operation mode that determines an action of the mobile body 10. FIG. 10 is a diagram illustrating an outline of an action policy according to the embodiment of the present disclosure. As illustrated in FIG. 10, three operation modes of a fully automatic mode, a video recording mode, and an advising mode are implemented as the action policy. The fully automatic mode is an operation mode of automatically executing: video recording of capturing an image of a state of a player performing a sport and recording a video; and advising for presenting useful information for proceeding with the sport to the player. The video recording mode is an operation mode specifically focusing on video recording of the player. The advising mode is an operation mode of specifically focusing on advising to the player (presentation of information useful for the player to proceed with a sport).

The setting information storage unit 1203 stores setting information predefined for each type of sport in order to determine the operation of the mobile body 10. As illustrated in FIG. 2 or FIG. 6 described above, the setting information stored in the setting information storage unit 1203 is constituted by associating an item of “sport type”, an item of “action policy”, and an item of “specific action” with each other.

Information set in the item of “sport type” is information specifying the type of sport. In the above example, for convenience of description, the name of the sport (golf or climbing) is indicated as the information for specifying the type of the sport. However, any information such as an ID may be used as long as the control device 120 can specify the type of the sport by the information.

Information set in the item of “action policy” is information designating the specific action of the mobile body 10. Examples of the action policy of the mobile body 10 to be implemented include a fully automatic mode, a video recording mode, and an advising mode. In the above example, for convenience of description, the name of the action policy is indicated as the information designating a specific action of the mobile body 10. However, any information may be used as long as the control device 120 can specify the action policy by the information.

Information set in the item of “specific action” includes information regarding specific action of the mobile body 10 corresponding to the information set in the item of “sport type” and the item of “action policy”. The item of “specific action” is divided into an item of “video recording” and an item of “advice”. For example, information set in the item of “video recording”, which is an action executed by the mobile body 10, is an imaging mode used in execution of video recording. Information set in the item of “advice” includes details of information to be provided to the player at every predetermined timing.

Returning to FIG. 9, the distance information acquisition unit 1204 acquires distance information from the distance sensor 111. The distance information acquisition unit 1204 transmits the acquired distance information to the object detection unit 1208, the human body detection unit 1210, the self-position calculation unit 1212, and the 3D environment recognition unit 1213.

The image information acquisition unit 1205 acquires image information from the image sensor 112. The image information acquisition unit 1205 transmits the acquired image information to the object detection unit 1208, the human body detection unit 1210, and the self-position calculation unit 1212. In addition, the image information acquisition unit 1205 transmits image information recorded by video recording of the imaging target, to the action control unit 1217.

The IMU information acquisition unit 1206 acquires IMU information from the IMU 113. The IMU information acquisition unit 1206 transmits the acquired IMU information to the self-position calculation unit 1212.

The GPS information acquisition unit 1207 acquires GPS information from the GPS sensor 114. The GPS information acquisition unit 1207 transmits the acquired GPS information to the self-position calculation unit 1212.

The object detection unit 1208 detects an object around the mobile body 10 based on the distance information acquired from the distance information acquisition unit 1204 and the image information acquired from the image information acquisition unit 1205. The object detection unit 1208 transmits the object information of the detected object to the object state recognition unit 1209.

The object state recognition unit 1209 recognizes the position, speed, motion, and the like of the object based on the object information acquired from the object detection unit 1208. The object state recognition unit 1209 transmits the recognition result to the situation recognition unit 1215.

The human body detection unit 1210 detects a human body around the mobile body 10 based on the distance information acquired from the distance information acquisition unit 1204 and the image information acquired from the image information acquisition unit 1205. The human body detection unit 1210 transmits the human body information regarding the detected human body, to the human body state recognition unit 1211.

The human body state recognition unit 1211 recognizes a position, orientation, a posture, a gender, a motion, and the like of a person based on the human body information acquired from the human body detection unit 1210. The human body state recognition unit 1211 transmits the recognition result to the situation recognition unit 1215.

The self-position calculation unit 1212 calculates the position, attitude, speed, angular velocity, and the like of the mobile body 10 based on the distance information acquired from the distance information acquisition unit 1204, the image information acquired from the image information acquisition unit 1205, the IMU information acquired from the IMU information acquisition unit 1206, and the GPS information acquired from the GPS information acquisition unit 1207. The self-position calculation unit 1212 transmits the calculated own-device information such as the position, attitude, speed, and angular velocity of the mobile body 10 to the 3D environment recognition unit 1213.

The 3D environment recognition unit 1213 creates a three-dimensional environmental map corresponding to the surrounding environment of the mobile body 10 using the distance information acquired from the distance information acquisition unit 1204 and own-vehicle information acquired from the self-position calculation unit 1212. The 3D environment recognition unit 1213 can create an environment structure expressed in any form such as grid, point cloud, or voxel. The 3D environment recognition unit 1213 transmits the created environmental map to the situation recognition unit 1215.

The data reception unit 1214 receives information transmitted from the terminal device 20, a non-own mobile body, or the like. The information received by the data reception unit 1214 includes GPS information indicating the position of the terminal device 20, the player information described above, an environmental map created by non-own mobile body, position information of a non-own player detected by a non-own mobile body, and the like. The data reception unit 1214 transmits the received information to the situation recognition unit 1215 and the action planning unit 1216.

The situation recognition unit 1215 recognizes the current situation in preparation for the imaging of the imaging target based on the object recognition result obtained by the object state recognition unit 1209, the human body recognition result obtained by the human body state recognition unit 1211, the environmental map created by the 3D environment recognition unit 1213, the imaging environment information stored in the environment information storage unit 1201, and the information received by the data reception unit 1214.

For example, the situation recognition unit 1215 grasps the positions, attitude/posture, motions, and the like of the object and the human body in the environmental map based on the GPS information received from the terminal device 20, the object recognition result, the human body recognition result, and the environmental map. In addition, the situation recognition unit 1215 grasps a detailed position, posture, and the like of the mobile body 10 by matching the environmental map and the imaging environment information. With these pieces of information, in a case where the imaging target is a golf player, the situation recognition unit 1215 recognizes a situation in which the timing is before a shot and the player who is the imaging target is about to hit a golf ball on a slope toward the green, and a head wind of 5 meters per second is blowing over the green. The situation recognition unit 1215 transmits the situation recognition result to the action planning unit 1216.

The action planning unit 1216 determines an action plan of the mobile body 10 based on the situation recognition result obtained by the situation recognition unit 1215 and the setting information stored in the setting information storage unit 1203.

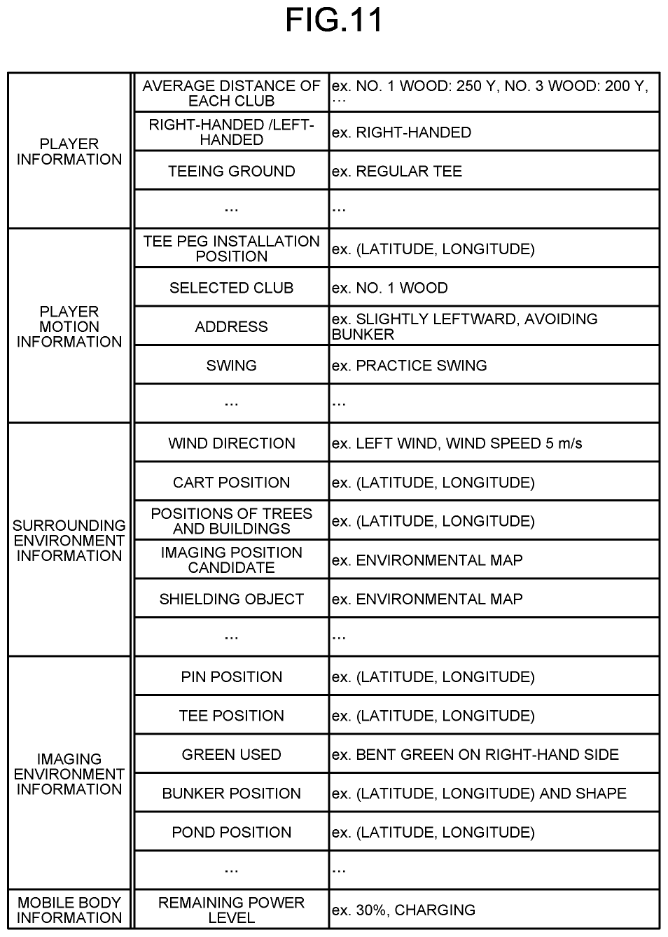

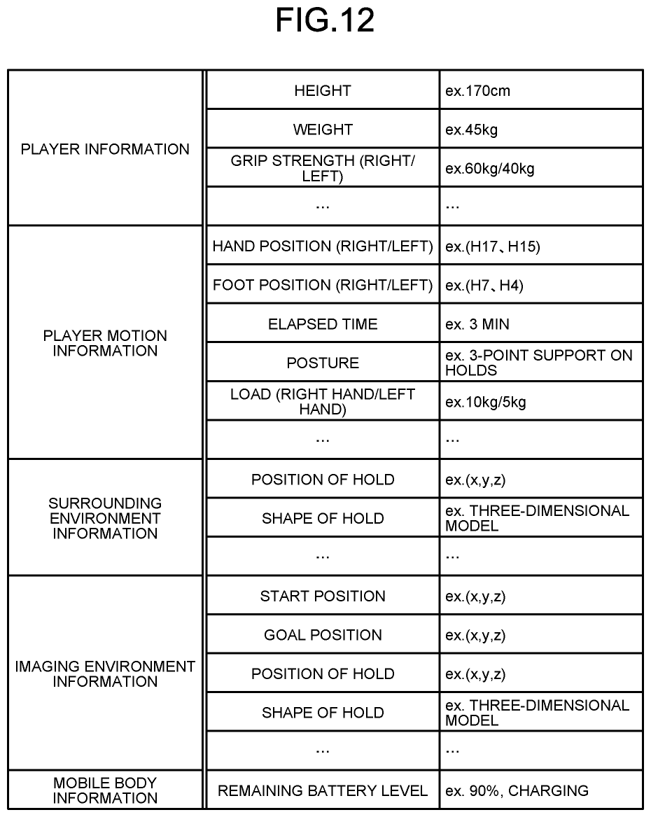

Specifically, the action planning unit 1216 selects a specific action corresponding to the sport type and the action policy acquired by the data reception unit 1214 from among pieces of the setting information stored in the setting information storage unit 1203. In order to control the mobile body 10 to operate based on the selected specific action, the action planning unit 1216 determines an action plan reflecting a situation recognition result indicating a recognition result of a current situation in preparation for the imaging of the imaging target. FIGS. 11 and 12 are diagrams illustrating specific examples of information acquired as a situation recognition result according to the embodiment of the present disclosure. FIG. 11 illustrates a specific example of information corresponding to golf. FIG. 12 illustrates a specific example of information corresponding to climbing.

As illustrated in FIG. 11, in a case where the sport type is golf, information acquired as the situation recognition result is information provided for appropriately performing video recording of golf. The information acquired as the situation recognition result regarding golf is not necessarily limited to the example illustrated in FIG. 11, and it is allowable to acquire information other than the information illustrated in FIG. 11. Furthermore, as illustrated in FIG. 12, in a case where the sport type is climbing, information acquired as the situation recognition result is information provided for appropriately performing video recording of climbing. Information to be set is information for appropriately recording a video corresponding to the situation of the player by tracking the movement of the player during climbing. The information acquired as the situation recognition result regarding climbing is not necessarily limited to the example illustrated in FIG. 11, and it is allowable to acquire information other than the information illustrated in FIG. 11.

Subsequently, the action planning unit 1216 determines a camera angle for performing video recording of the imaging target in accordance with the specific action of the mobile body 10 selected based on the setting information. After determining the camera angle, the action planning unit 1216 determines an action plan for causing the mobile body 10 to perform video recording of the imaging target. The action plan determined by the action planning unit 1216 includes a movement plan for moving the mobile body 10 to the imaging position. For example, the action planning unit 1216 determines a movement plan for moving the mobile body 10 to the imaging position based on the position and posture of the imaging target on the environmental map, the position and attitude of the mobile body 10 on the environmental map, and the like. For example, the action planning unit 1216 can plan an optimal route to the imaging position by applying a certain search algorithm to the environmental map. The action planning unit 1216 determines an action plan of the mobile body 10, specifically, a plan of moving along the movement route based on the movement plan to the imaging position and executing the video recording of the imaging target.

The action control unit 1217 controls the action of the mobile body 10 based on the action plan created by the action planning unit 1216 and the GPS information received from the terminal device 20. For example, the action control unit 1217 compares the state (position, attitude, and the like) of the mobile body 10 on the environmental map with the state (movement route, specific action) of the mobile body 10 planned in the action plan, and controls the action of the mobile body 10 so that the state of the mobile body 10 approaches the state planned in the action plan. The action control unit 1217 controls the image sensor 112 and the image information acquisition unit 1205 according to the action plan, and executes video recording of the imaging target. The action control unit 1217 transmits the image information recorded by the video recording of the imaging target to the data transmission unit 1218. For example, the action control unit 1217 transmits data such as a captured image and position information of an imaging target to the data transmission unit 1218.

The data transmission unit 1218 transmits the image information acquired from the action control unit 1217 to the terminal device 20. The data transmission unit 1218 can transmit the image information to the terminal device 20 at any timing set by the user of the terminal device 20, for example. The data transmission unit 1218 functions as a transmission unit that transmits image information recorded by video recording to the terminal device 20 possessed by the user as the imaging target at a predetermined timing.

(3-1-1. Exemplary Imaging Mode)

Hereinafter, an example of the imaging mode implemented in the video recording mode which is one of the action policies of the mobile body 10 will be described. FIGS. 13 to 16 are schematic diagrams illustrating an outline of the imaging mode according to the embodiment of the present disclosure. Hereinafter, an imaging mode in a case where the imaging scene is golf will be described.

The video recording mode implements three imaging modes, namely, a first imaging mode, a second imaging mode, and a third imaging mode.

The first imaging mode is an imaging mode of recording an image captured from a side of the player. In the first imaging mode, imaging is performed from a side in a backswing direction opposite to the position of the pin P from the player U, among the sides of the player U. FIG. 13 illustrates a state of imaging of the right-handed player. As illustrated in FIG. 13, the mobile body 10 that performs imaging in the second imaging mode moves from the cart K to an optimal imaging position, and images the state of the shot of the player U from the side of the player U of golf. In addition, the mobile body 10 moves to a next shot point after the shot of the player, and performs imaging similarly. The first imaging mode is assumed to be selected by the player U who wishes to confirm the trajectory of the backswing, for example.

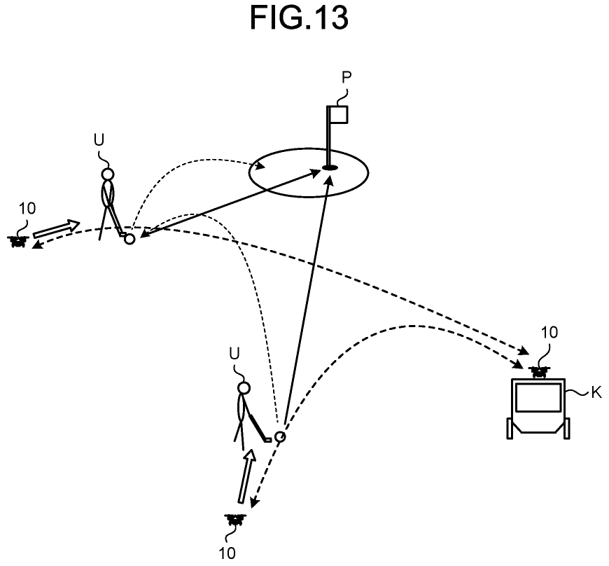

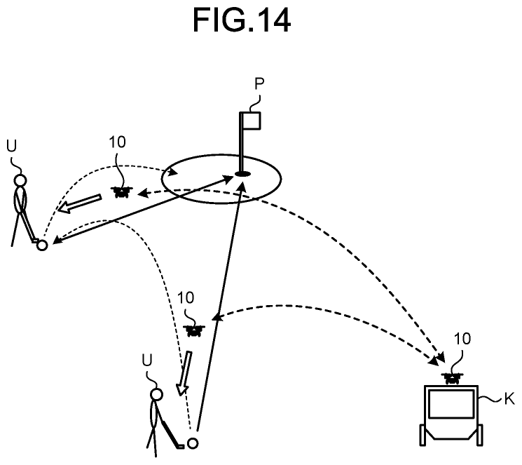

The second imaging mode is an imaging mode of recording an image captured from the side of the player opposite to direction of the first imaging mode. That is, in the second imaging mode, imaging is performed from the side in a follow swing direction from the player U toward the position of the pin P, among the sides of the player U. For example, FIG. 14 illustrates a state of imaging of the right-handed player U. As illustrated in FIG. 14, the mobile body 10 that performs imaging in the second imaging mode moves from the cart K to an optimal imaging position, and images the state of the shot of the player U from the front of the player U of golf. In addition, the mobile body 10 moves to a next shot point after the shot of the player, and performs imaging similarly. The first imaging mode is assumed to be selected by the player U who wishes to confirm the trajectory of the follow swing, for example.

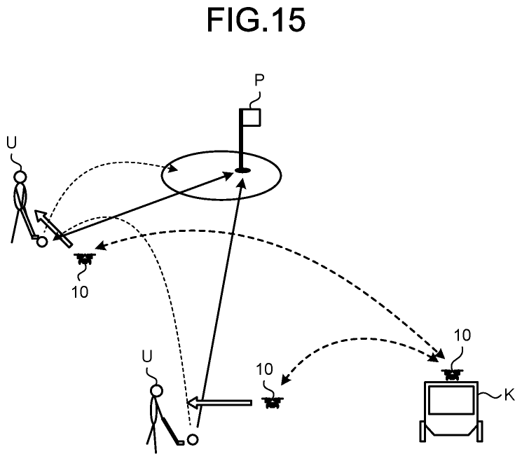

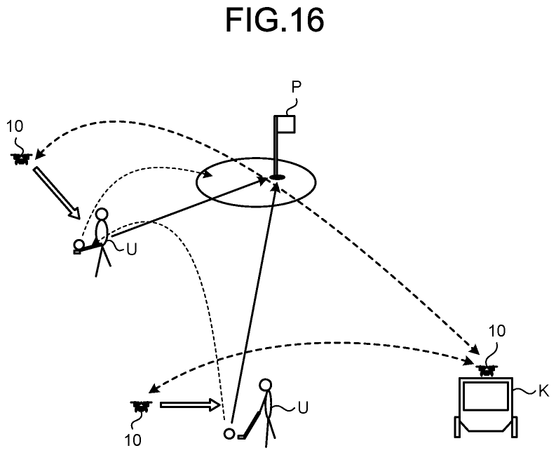

The third imaging mode is an imaging mode of recording an image captured from the front of the player. For example, FIG. 15 illustrates a state of imaging of the right-handed player U. FIG. 16 illustrates a state of imaging of a left-handed player. As illustrated in FIGS. 15 and 16, the mobile body 10 that performs imaging in the third imaging mode moves from the cart K to an optimal imaging position, and images the state of the shot of the player U from the front of the player U of golf. In addition, the mobile body 10 moves to a next shot point after the shot of the player, and performs imaging similarly. The first imaging mode is assumed to be selected by the player U who wishes to confirm the moment of impact, for example. Incidentally, the mobile body 10 may return to the cart K and charge while the player U is moving between shots.

(3-1-2. Video Provision Example)

The mobile body 10 can provide the recorded video to the user at a predetermined timing. FIGS. 17 to 20 are schematic diagrams each illustrating an outline of information provision according to the embodiment of the present disclosure. Hereinafter, an example of providing a variety of information such as a recorded video to a user who is playing golf will be described. The operation of the mobile body 10 described below is implemented by the control device 120 mounted on the mobile body 10.

In golf play, there are not a few players who wish to quickly check the result of a shot. Therefore, as illustrated in FIG. 17, after capturing the moment of the shot, the mobile body 10 can record videos of a plurality of scenes for notifying the player U of information such as a result of the shot and can provide the videos to the player U. After recording the video of the moment of the shot, the mobile body 10 records videos such as a video EZ2 of the position and situation of the golf ball BL, a video EZ3 of overlooking the positional relationship between the golf ball BL and the pin P, and a video EZ4 of looking the direction of the pin P from the position of the golf ball BL. When the shot of the player U is finished and the position of the golf ball BL is determined, the mobile body 10 provides the player U with each piece of recorded video information by transmission to the terminal device 20.

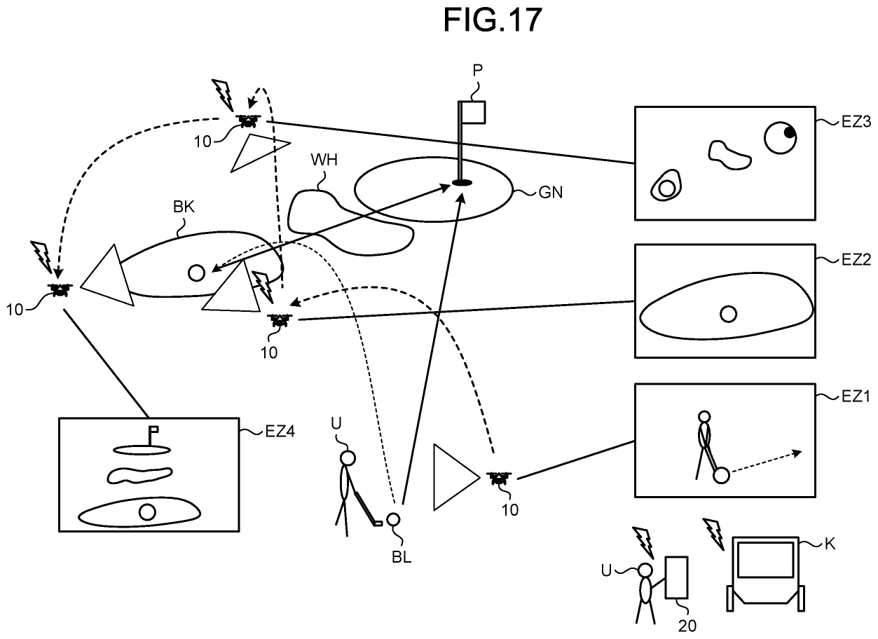

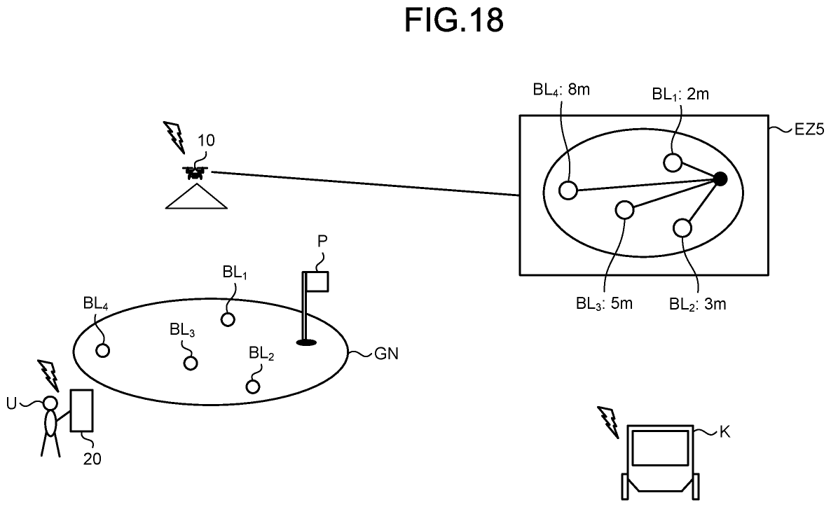

In addition, there is a rule in golf that when a plurality of golf balls is located on a green, a player farthest from a pin performs putting. Therefore, as illustrated in FIG. 18, the mobile body 10 images the state of the ball BL located on the green GN and provides the player U with a recorded video EZ5 by transmission to the terminal device 20. Incidentally, the mobile body 10 may measure the distance between the golf ball located on the green GN and the pin P and include the distance in the video to be provided to the player U.

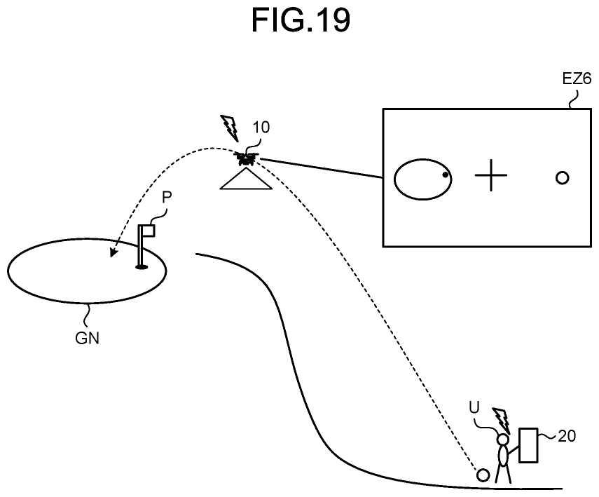

In addition, there can be occurrence of a situation, in golf play, in which a shot is performed in a situation with a poor visibility, that is, a situation in which the position of the pin on the green is not visible. Therefore, as illustrated in FIG. 19, the mobile body 10 captures a bird's-eye view image of a positional relationship among the position of the player U, the position of the pin P, and the position of the own device, and provides the player U with a recorded bird's-eye view image EZ6 by transmission to the terminal device 20.

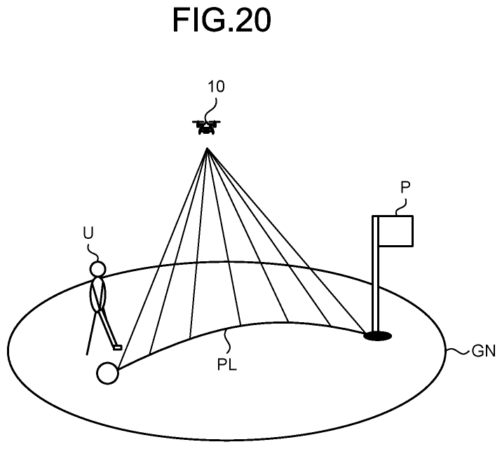

Furthermore, the mobile body 10 may determine execution of a motion useful for the player to proceed with a sport, as part of the action plan. For example, the mobile body 10 floats in the air on a straight line connecting the position of the player U and the position of the pin P, and presents the shot direction of the player U using the position of the mobile body. Moreover, it may be difficult, in golf play, to determine a putting line on a green. Therefore, as illustrated in FIG. 20, the mobile body 10 projects a video indicating a putting line PL on the green GN by projection mapping or the like, and provides the video to the player U.

(3-1-3. Cooperation with Non-Own Mobile Bodies)

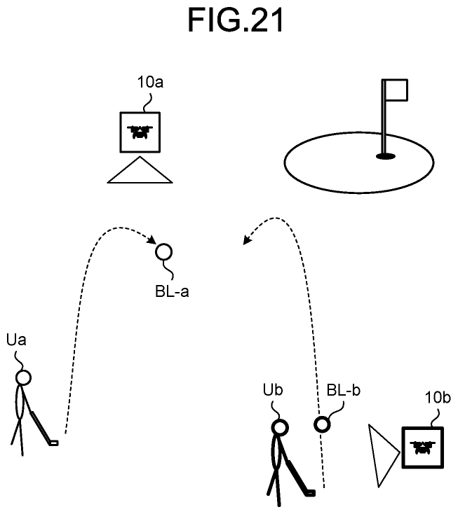

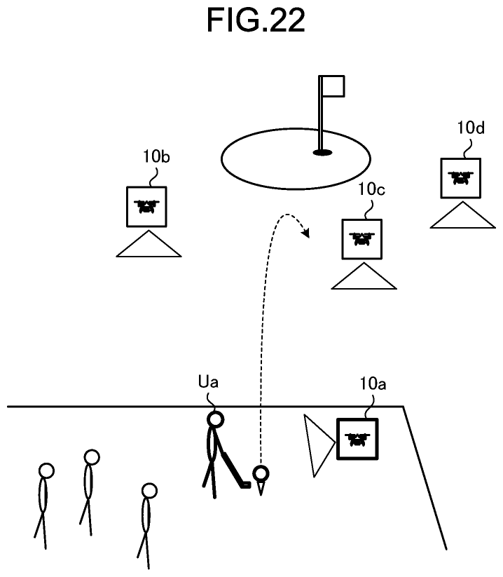

In the above embodiment, the mobile body 10 may perform processing in cooperation with a non-own mobile body (control device). FIGS. 21 and 22 are diagrams illustrating an outline of cooperative processing between mobile bodies according to the embodiment of the present disclosure. The operation of the mobile body 10 described below is implemented by the control device 120 mounted on the mobile body 10.

In the example illustrated in FIG. 21, it is assumed that a mobile body 10ₐ and a mobile body 10_{b} share an environmental map and share the mutual positions, the mutual situations of the imaging targets, and the like. In addition, it is assumed that the mobile body 10a plays a role of video recording of a player Ua, while the mobile body 10b plays a role of video recording of a player Ub.

At this time, when having determined that the predicted falling point of a ball BL-b hit by the player Ub as an imaging target is within a predetermined range from the falling point of a ball BL-a of the player Ua, the mobile body 10b transmits information regarding the predicted falling point of the ball BL-b to the mobile body 10a.

When having received the information regarding the predicted falling point of the ball BL-b from the mobile body 10b, the mobile body 10a searches for the location of the ball BL-b based on the information regarding the predicted fall point. Subsequently, when having found the ball BL-b, the mobile body 10a transmits the position of the ball BL-b to the mobile body 10b.

Furthermore, in the example illustrated in FIG. 22, it is assumed that the mobile body 10a, the mobile body 10b, a mobile body 10c, and a mobile body 10d share an environmental map, and share the mutual positions, the mutual situations of the imaging targets, and the like. In addition, it is assumed that the mobile body 10a shares roles such that the mobile body 10a captures an image of the moment of a tee shot of the player Ua as an imaging target, and the mobile body 10b to the mobile body 10d capture an image of the state of batting.

At this time, the mobile body 10a transmits information such as a predicted trajectory and a predicted falling point of the ball BL-a hit by the player Ua to the mobile bodies 10b to 10d. When the mobile body 10b to the mobile body 10d have received the information such as the predicted trajectory and the predicted falling point from the mobile body 10a, each of the mobile body 10b to the mobile body 10d autonomously acts based on the information, and images the state of hitting. For example, it is conceivable that, among the mobile body 10b to the mobile body 10d, the mobile body closest to the predicted trajectory captures an image of the state of the flying ball, and the mobile body closest to the predicted falling point searches for the location of the ball BL-a.

(3-1-4. Cooperation with Wearable Device)

In the above embodiment, the mobile body 10 may cooperate with a wearable device such as eyeglasses worn by the user. FIG. 23 is a diagram illustrating an outline of a cooperative processing between the mobile body and a wearable device according to the embodiment of the present disclosure. The operation of the mobile body 10 described below is implemented by the control device 120 mounted on the mobile body 10.

As illustrated in FIG. 23, the mobile body 10 cooperates with a wearable device WD worn by the player U as an imaging target. The mobile body 10 images the player U and transmits a recorded video EZ7 to the wearable device WD.

(3-1-5. Imaging from Structure)

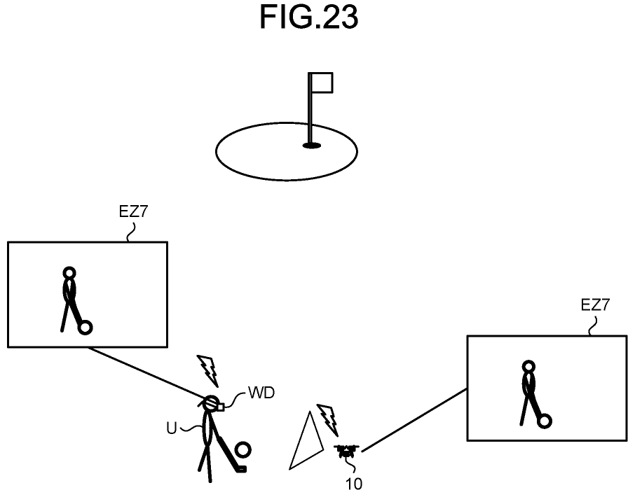

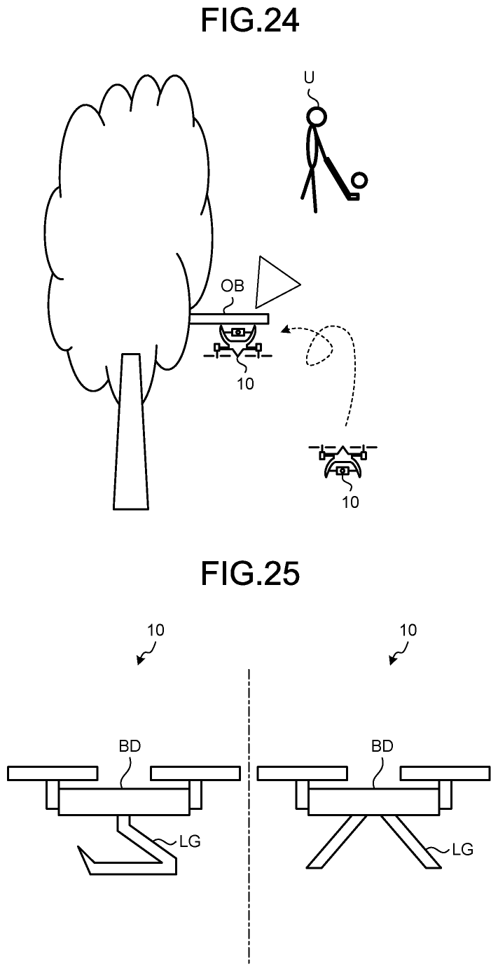

In the above-described embodiment, the mobile body 10 may be attached to a structure such as a tree branch to execute video recording of an imaging target or the like. FIG. 24 is a schematic diagram illustrating an outline of imaging from a structure according to the embodiment of the present disclosure. The operation of the mobile body 10 described below is implemented by the control device 120 mounted on the mobile body 10.

As illustrated in FIG. 24, the mobile body 10 searches for a structure to which the mobile body 10 can be attached and that can keep holding a camera angle for imaging the player U as an imaging target, that is, searches whether such a structure exists around the own vehicle. In a case where the mobile body 10 has found a structure OB that can be attached to the mobile body 10, the mobile body 10 is attached to the structure OB and images the state of the shot of the player U. FIG. 25 is a diagram illustrating an example of a landing gear of a mobile body according to the embodiment of the present disclosure.

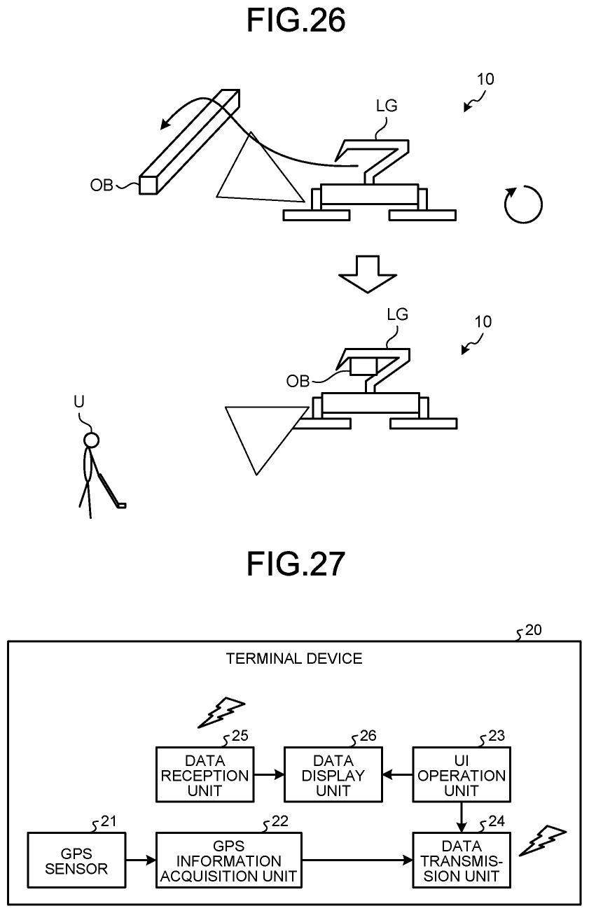

The diagram on the left in FIG. 25 illustrates a side surface of a landing gear LG included in the mobile body 10, and the diagram on the right in FIG. 25 illustrates a front surface of the landing gear LG included in the mobile body 10. As illustrated in FIG. 25, the mobile body 10 includes the landing gear LG coupled to a main body BD. The landing gear LG illustrated in FIG. 25 has a hook shape. In a normal moving state, the mobile body 10 flies with the landing gear LG facing downward. On the other hand, in a case where the mobile body 10 is attached to the structure OB, unlike a case where the mobile body is in the normal moving state, the mobile body flies with a state in which positions of the main body BD and the landing gear LG are turned upside down. FIG. 26 is a view illustrating a state in which the landing gear of the mobile body according to the embodiment of the present disclosure is attached to the structure.

As illustrated in FIG. 26, the mobile body 10, which faces downward in a normal moving state, turns the landing gear LG upward by performing rear flight. This makes it possible for the mobile body 10 to be attached to the structure OB by hooking the hook-shaped landing gear LG on the structure OB. With the mobile body 10 attached to the structure OB, there is no need to perform aerial levitation, leading to power saving.

(3-2. Configuration of Terminal Device)

Hereinafter, a configuration of a terminal device according to the embodiment of the present disclosure will be described. FIG. 27 is a block diagram illustrating a configuration example of a terminal device according to the embodiment of the present disclosure.

The terminal device 20 is an information processing device carried by a user performing a sport, and is typically an electronic device such as a smartphone. An information processing device 100 may be a device such as a mobile phone, a tablet, a wearable device, a personal digital assistant (PDA), or a personal computer.

As illustrated in FIG. 27, the terminal device 20 includes functional units for implementation of information processing according to the embodiment of the present disclosure, specifically including a GPS sensor 21, a GPS information acquisition unit 22, a user interface (UI) operation unit 23, a data transmission unit 24, a data reception unit 25, and a data display unit 26.

Each functional unit included in the terminal device 20 is implemented by a control circuit including a processor and memory. Each functional unit included in the terminal device 20 is implemented by executing a command described in a program read from internal memory by the processor using the internal memory as a work area, for example. The program read from the internal memory by the processor includes an operating system (OS) and an application program. In addition, each of the functional units included in the terminal device 20 may be implemented by an integrated circuit such as an application specific integrated circuit (ASIC) and a field-programmable gate array (FPGA).

Furthermore, a main storage device and an auxiliary storage device functioning as the internal memory described above are implemented by a semiconductor memory element such as random access memory (RAN) or flash memory, or a storage device such as a hard disk or an optical disk.

The GPS sensor 21 measures the position (latitude and longitude) of the terminal device 20 and acquires GPS information. The GPS sensor 21 transmits the acquired GPS information to the GPS information acquisition unit 22.

The GPS information acquisition unit 22 acquires GPS information from the GPS sensor 21. The GPS information acquisition unit 22 transmits the acquired GPS information to the data transmission unit 24.

The UI operation unit 23 receives user's operation input via a user interface displayed on the data display unit 26, and acquires a variety of information input to the user interface. The UI operation unit 23 can be implemented by, for example, a variety of buttons, a keyboard, a touch panel, a mouse, a switch, a microphone, and the like. The information acquired by the UI operation unit 23 includes information such as user ID set at the time of connection with the mobile body 10, player information, and action policy information. The UI operation unit 23 transmits the input the variety of information to the data transmission unit 24.

The data transmission unit 24 transmits the variety of information to the mobile body 10. The data transmission unit 24 transmits information such as GPS information, player information, and action policy information acquired from the GPS acquisition unit, to the mobile body 10.

The data reception unit 25 receives the variety of information from the mobile body 10. The information received by the data reception unit 25 includes image information captured by the mobile body 10. The data reception unit 25 transmits the variety of information received from the mobile body 10 to the data display unit 26.

The data transmission unit 24 and the data reception unit 25 described above can be implemented by a device such as a network interface card (NIC) and a variety of communication modems.

The data display unit 26 displays a variety of information. The data display unit 26 can be implemented by using a display device such as a cathode ray tube (CRT), a liquid crystal display (LCD), or an organic light emitting diode (OLED). The data display unit 26 displays a user interface for receiving an operation input from the user of the terminal device 20. In addition, the data display unit 26 displays the image information received from the mobile body 10.

### 4. Processing Procedure Examples

(4-1. Overall Processing Flow)

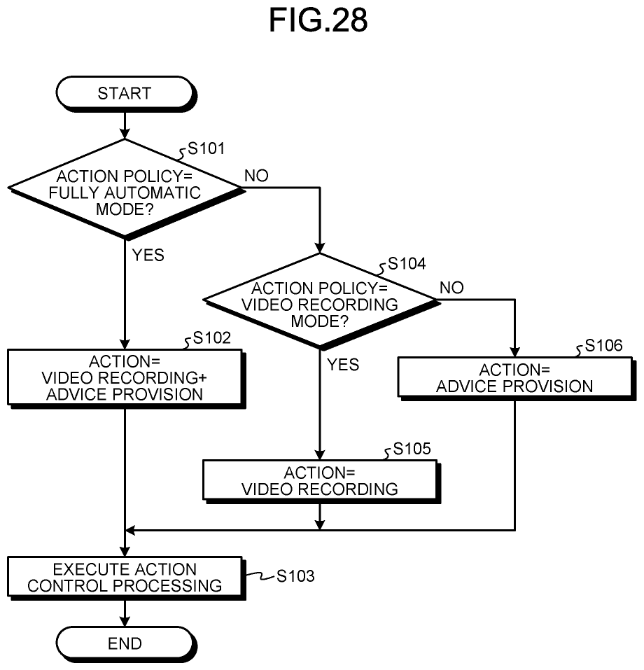

Hereinafter, a processing procedure example of the control device 120 according to the embodiment of the present disclosure will be described with reference to FIGS. 28 to 31. First, an overall processing flow by the control device 120 according to the embodiment of the present disclosure will be described with reference to FIG. 28. FIG. 28 is a flowchart illustrating an overall processing procedure example of a control device according to the embodiment of the present disclosure. The processing procedure example illustrated in FIG. 28 is executed by the control device 120.

As illustrated in FIG. 28, the control device 120 judges whether the action policy of the mobile body 10 designated by the user of the terminal device 20 is the fully automatic mode (step S101).

When having judged that the action policy is the fully automatic mode (step S101, Yes), the control device 120 refers to the setting information corresponding to the sport type received from the terminal device 20 and determines the specific action of the mobile body 10 as “video recording+advice” (step S102).

Subsequently, the control device 120 executes action control processing (refer to FIGS. 28 to 31 to be described below) of the mobile body 10 according to the fully automatic mode (step S103), and ends the processing procedure illustrated in FIG. 28.

When having judged, in step S101 described above, that the action policy is not the fully automatic mode (step S101, No), the control device 120 determines whether the action policy is the video recording mode (step S104).

When having judged that the action policy is the video recording mode (step S104, Yes), the control device 120 determines that an operation of the specific action of the mobile body 10 is “video recording” (step S105).

Subsequently, the control device 120 moves to the processing procedure of step S103 described above, executes the action control processing of the mobile body 10 according to the video recording mode, and ends the processing illustrated in FIG. 28.

When having judged, in step S104 described above, that the action policy is not the video recording mode (step S104, No), the control device 120 judges that the action policy is the advising mode, and determines the specific action of the mobile body 10 as “advice” (step S106).

Subsequently, the action planning unit 1216 moves to the processing procedure of step S103 described above, executes action control processing of the mobile body 10 according to the advising mode, and ends the processing illustrated in FIG. 28.

(4-2. Action Control Processing)

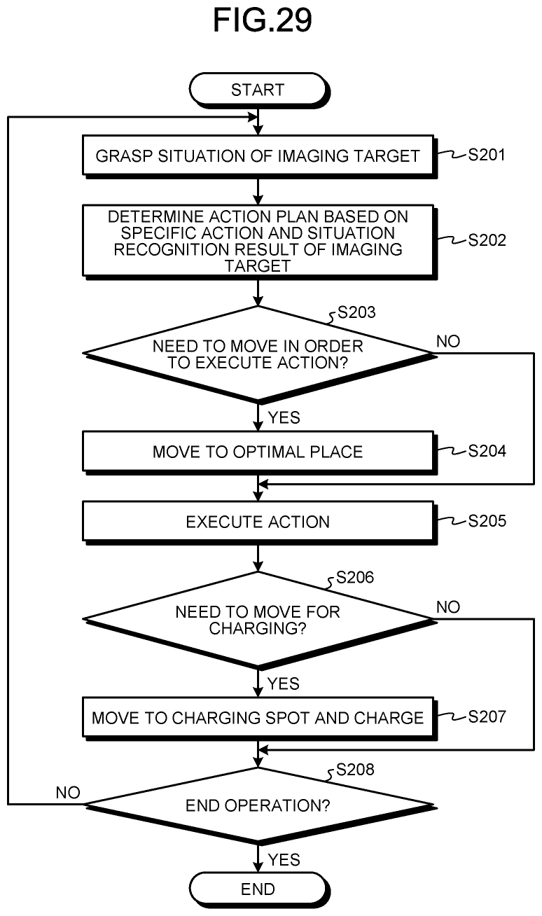

Next, a flow of action control processing performed by the control device 120 according to the embodiment of the present disclosure will be described with reference to FIG. 29. FIG. 29 is a flowchart illustrating a processing procedure example of action control processing of the control device according to the embodiment of the present disclosure. The processing procedure example illustrated in FIG. 29 is repeatedly executed by the control device 120 during the operation of the mobile body 10.

As illustrated in FIG. 29, the control device 120 grasps the situation of the imaging target (step S201). That is, the control device 120 acquires a situation recognition result indicating a recognition result of a situation in which the imaging target is placed.

The control device 120 determines an action plan of the mobile body 10 based on the specific action corresponding to the action policy determined in the processing procedure of FIG. 28 and the situation of the imaging target (step S202).

Subsequently, the control device 120 judges whether there is a need to move in order to execute an action according to the action plan (step S203).

When having judged that there is a need to move in order to execute the action (step S203, Yes), the control device 120 searches for an optimal place for executing the action, moves to the optimal place (step S204), and executes the action according to the action plan (step S205). In contrast, when having judged that there is no need to move to execute the action (step S203, No), the control device 120 proceeds to the processing procedure of step S205 described above and executes the action according to the action plan.

After executing the action according to the action plan, the control device 120 judges whether there is a need to move for charging (step S206).

When having judged that there is a need to move for charging (step S206, Yes), the control device 120 moves to a charging spot and charges the battery (step S207). In contrast, when having judged that there is no need to move for charging (step S206, No), the control device 120 proceeds to the processing procedure of step S208 described below.

The control device 120 judges whether to end the operation of the mobile body 10 (step S208). When having judged not to end the operation of the mobile body 10 (step S208, No), the control device 120 returns to the processing procedure of step S201 and continues the processing procedure illustrated in FIG. 29. In contrast, when having judged to end the operation of the mobile body 10 (step S208, Yes), the control device 120 ends the processing procedure illustrated in FIG. 29.

(4-3. Specific Processing Procedure Example of Action Control Processing)

(4-3-1. Specific Processing Procedure Example Corresponding to Golf)

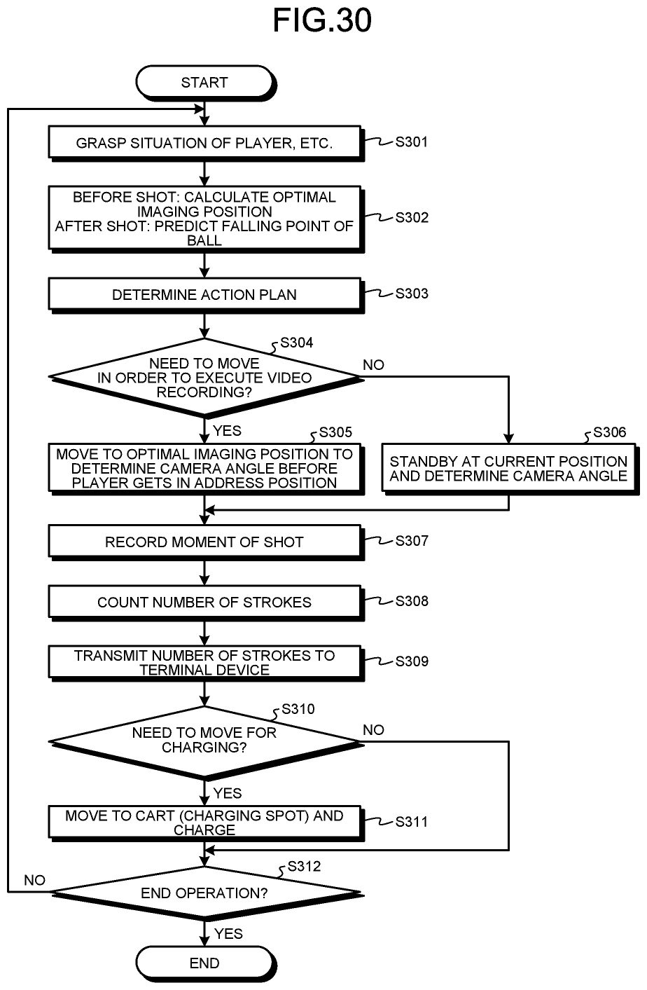

Next, a specific processing procedure example of the action control processing corresponding to golf will be described with reference to FIG. 30. FIG. 30 is a flowchart illustrating a specific processing procedure example (1) of the action control processing of the control device according to the embodiment of the present disclosure. FIG. 30 illustrates a processing procedure example in a case where the action policy designated by the user is the “video recording mode”.

As illustrated in FIG. 30, the control device 120 grasps a situation and the like of a player or the like as an imaging target (step S301). That is, the control device 120 acquires a situation recognition result indicating a recognition result of the situation of the player and the like (such as a positional relationship between the player and the hold). For example, the control device 120 acquires a specific situation in which, specifically, the player U, being a right handed player and using the regular tee with an average drive distance of the No. 1 wood of 250 yards, is performing practice swing before the tee shot in the ninth hole with a dogleg to the left.

From the situation of the player and the like, the control device 120 searches for an optimal imaging position in a case where the player is before the shot, and predicts a falling point of the ball based on the hitting angle of the golf ball in a case where the player is after the shot (step S302).

Subsequently, the control device 120 determines the action plan of the mobile body 10 based on the specific action based on the action policy designated by the player and the situation of the player or the like (step S303). That is, in order to control the mobile body 10 to operate based on the specific action corresponding to the action policy, the control device 120 determines an action plan reflecting the situation recognition result indicating the recognition result of the current situation in preparation for the imaging of the player or the like who is the imaging target.

The control device 120 determines whether there is a need to move in order to execute the video recording following the action plan (step S304).

When having judged that there is a need to move to execute the video recording (step S304, Yes), the control device 120 moves to an optimal place before the player enters the address, and determines a camera angle for imaging the state of the player (step S305). For example, the optimal location corresponds to an imaging position at which the moment of the tee shot can be imaged with a composition predetermined in an imaging mode selected in accordance with the situation of the player or the like (for example, before a tee shot).

In contrast, when having judged that there is no need to move to execute the video recording (step S304, No), the control device 120 waits at the current position and determines the camera angle (step S306), and moves to the processing procedure of the next step S307.

The control device 120 records the moment of the shot at the camera angle determined (step S307). Note that, in a case where the action policy is the fully automatic mode or the advising mode, the control device 120 can transmit, to the terminal device 20, video images such as a video of the position and situation of the golf ball, a video of a bird's eye view of the positional relationship between the golf ball and the pin, and a video E of the direction of the pin viewed from the position of the golf ball to be presented to the player. When having judged that the result of the player's shot is a penalty such as OB, the control device 120 can transmit the result to the terminal device 20 to notify the player of the penalty. In addition, in a case where the player wears a wearable device such as eyeglasses, the control device 120 can transmit, to the wearable device, a video or the like for notifying the current situation of the player.

Subsequently, the control device 120 counts the number of strokes of the player who has performed the shot (step S308). The control device 120 transmits the counted number of strokes to the terminal device 20 possessed by the player U who made the shot (step S309).

Subsequently, the control device 120 determines whether there is a need to move for charging (step S310).

When having judged that there is a need to move for charging (step S310, Yes), the control device 120 moves to a cart (charging spot) and charges the battery (step S311). In contrast, when having judged that there is no need to move for charging (step S310, No), the control device 120 proceeds to the processing procedure of next step S312.

The control device 120 determines whether to end the operation of the mobile body 10 (step S312). When having judged not to end the operation of the mobile body 10 (step S312, No), the control device 120 returns to the processing procedure of step S301 and continues the processing procedure illustrated in FIG. 30. In contrast, when having judged to end the operation of the mobile body 10 (step S312, Yes), the control device 120 ends the processing procedure illustrated in FIG. 30.

(4-3-2. Specific Processing Procedure Example Corresponding to Climbing)

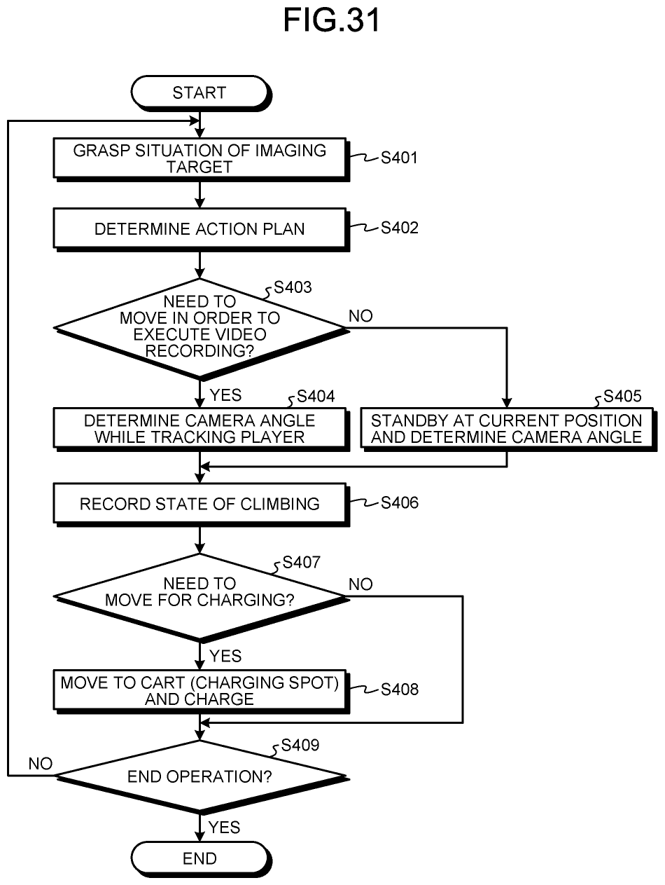

Next, a specific processing procedure example of the action control processing corresponding to climbing will be described with reference to FIG. 31. FIG. 31 is a flowchart illustrating a specific processing procedure example (2) of the action control processing of the control device according to the embodiment of the present disclosure. FIG. 31 illustrates a processing procedure example in a case where the action policy designated by the user is the “video recording mode”.

As illustrated in FIG. 31, the control device 120 grasps a situation of a player or the like as an imaging target (step S401). For example, the control device 120 acquires a specific situation in which the player U is 170 cm in height, 45 kilograms in weight, 60 kilograms in grip strength of the right hand, and 40 kilograms in grip strength of the left hand, and the player U has its right hand positioned at a “hold (H17)”, its left hand at a “hold (H15)”, its right foot at a “hold (H7)”, and its left foot at a “hole (H4)”.

The control device 120 determines the action plan of the mobile body 10 based on the specific action based on the action policy designated by the player and the situation of the player or the like (step S402). That is, in order to control the mobile body 10 to operate based on the specific action corresponding to the action policy, the control device 120 determines an action plan reflecting the situation recognition result indicating the recognition result of the current situation in preparation for the imaging of the player or the like who is the imaging target.

The control device 120 determines whether there is a need to move in order to execute the video recording following the action plan (step S403).

When having judged that there is a need to move to execute the video recording (step S403, Yes), the control device 120 searches for an optimal imaging position while tracking the player, and determines the camera angle (step S404).

In contrast, when having judged that there is no need to move to execute the video recording (step S403, No), the control device 120 waits at the current position and determines the camera angle (step S405).

Then, the control device 120 records the state of climbing at the determined camera angle (step S406). In a case where the action policy is the fully automatic mode or the advising mode, the control device 120 can present the position of the hold to move to next to the player using projection mapping or the like based on information such as player information (such as height, length of four limbs, and grip strength), and player motion information (such as position of the hold being used), the surrounding environment information (such as unevenness of the wall). In addition, in a case where the player wears a wearable device such as eyeglasses, the control device 120 can transmit, to the wearable device, a bird's-eye view image or the like for notifying the current situation of the player.

Subsequently, the control device 120 determines whether there is a need to move for charging (step S407).

When having judged that there is a need to move for charging (step S407, Yes), the control device 120 moves to a cart (charging spot) and charges the battery (step S408). In contrast, when having judged that there is no need to move for charging (step S407, No), the control device 120 proceeds to the processing procedure of next step S409.

The control device 120 determines whether to end the operation of the mobile body 10 (step S409). When having judged not to end the operation of the mobile body 10 (step S409, No), the control device 120 returns to the processing procedure of step S401 and continues the processing procedure illustrated in FIG. 31. In contrast, when having judged to end the operation of the mobile body 10 (step S409, Yes), the control device 120 ends the processing procedure illustrated in FIG. 31.

### 5. Modification

(5-1. Determination of Action Plan by Terminal Device)

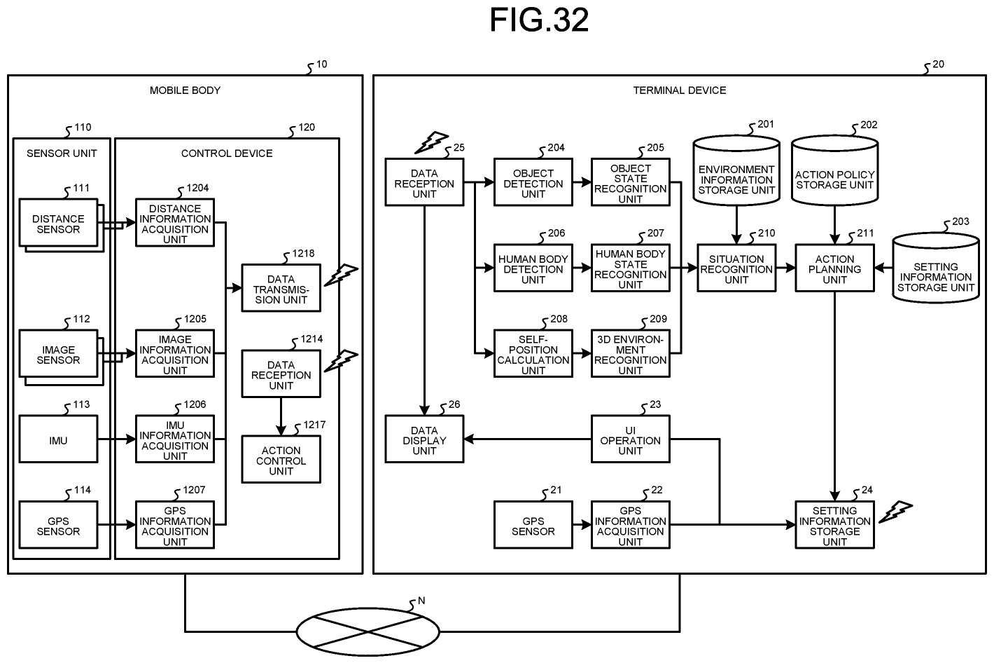

The above embodiment has described an example in which the control device 120 included in the mobile body 10 executes information processing for determining the action plan of the mobile body 10. Alternatively, the information processing for determining the action plan of the mobile body 10 may be executed by the terminal device 20. FIG. 32 is a block diagram illustrating a device configuration example according to a modification.

As illustrated in FIG. 32, the terminal device 20 includes an environment information storage unit 201, an action policy storage unit 202, and a setting information storage unit 203. The environment information storage unit 201 corresponds to the environment information storage unit 1201 illustrated in FIG. 9. The action policy storage unit 202 corresponds to the action policy storage unit 1202 illustrated in FIG. 9. The setting information storage unit 203 corresponds to the setting information storage unit 1203 illustrated in FIG. 9.

Furthermore, as illustrated in FIG. 32, the terminal device 20 includes an object detection unit 204, an object state recognition unit 205, a human body detection unit 206, a human body state recognition unit 207, a self-position calculation unit 208, and a 3D environment recognition unit 209. The object detection unit 204 corresponds to the object detection unit 1208 illustrated in FIG. 9. The object state recognition unit 205 corresponds to the object state recognition unit 1209 illustrated in FIG. 9. The human body detection unit 206 corresponds to the human body detection unit 1210 illustrated in FIG. 9. The human body state recognition unit 207 corresponds to the human body state recognition unit 1211 illustrated in FIG. 9. The self-position calculation unit 208 corresponds to the self-position calculation unit 1212 illustrated in FIG. 9. The 3D environment recognition unit 209 corresponds to the 3D environment recognition unit 1213 illustrated in FIG. 9.

Furthermore, as illustrated in FIG. 32, the terminal device 20 includes a situation recognition unit 210 and an action planning unit 211. The situation recognition unit 210 corresponds to the situation recognition unit 1215 illustrated in FIG. 9. The action planning unit 211 corresponds to the action planning unit 1216 illustrated in FIG. 9.

On the other hand, as illustrated in FIG. 32, the control device 120 included in the mobile body 10 includes a part of the units illustrated in FIG. 9, that is, the distance information acquisition unit 1204, the image information acquisition unit 1205, the IMU information acquisition unit 1206, the GPS information acquisition unit 1207, the data reception unit 1214, an action control unit 1217, and the data transmission unit 1218.

The data transmission unit 1218 of the control device 120 transmits, to the terminal device 20, the distance information acquired by the distance information acquisition unit 1204, the image information acquired by the image information acquisition unit 1205, the IMU information acquired by the IMU information acquisition unit 1206, and the GPS information acquired by the GPS information acquisition unit 1207.

The terminal device 20 executes information processing similar to the processing of the control device 120 illustrated in FIG. 9 based on the information acquired from the control device 120.

The data reception unit 25 receives the distance information, the image information, the IMU information, and the GPS information from the mobile body 10. The object state recognition unit 205 performs processing corresponding to the object state recognition unit 1209 and transmits a processing result to the situation recognition unit 210. The human body state recognition unit 207 performs processing corresponding to the human body state recognition unit 1211 and transmits a processing result to the situation recognition unit 210. The self-position calculation unit 208 performs processing corresponding to the self-position calculation unit 1212 and transmits a processing result to the situation recognition unit 210. The 3D environment recognition unit 209 performs processing corresponding to the 3D environment recognition unit 1213, and transmits the processing result to the situation recognition unit 210.

The situation recognition unit 210 performs processing corresponding to the situation recognition unit 1215. That is, the situation recognition unit 210 recognizes the current situation in preparation for the imaging of the imaging target (such as a player, goods) based on the object recognition result obtained by the object state recognition unit 205, the human body recognition result obtained by the human body state recognition unit 207, the environmental map created by the 3D environment recognition unit 209, the imaging environment information stored in the environment information storage unit 201, and the information received by the data reception unit 25. The situation recognition unit 210 transmits the processing result to the action planning unit 211.

The action planning unit 211 performs processing corresponding to the action planning unit 1216. That is, the action planning unit 211 determines an action plan of the mobile body 10 based on the situation recognition result obtained by the situation recognition unit 210 and the setting information stored in the setting information storage unit 203. The action planning unit 211 transmits the determined action plan to the data transmission unit 24.

The data transmission unit 24 transmits the action plan determined by the action planning unit 211 to the mobile body 10 together with the GPS information acquired by the GPS information acquisition unit 22.

The data reception unit 1214 of the control device 120 transmits the GPS information and the action plan received from the terminal device 20 to the action control unit 1217.

The action control unit 1217 controls an action of the mobile body 10 based on the GPS information and the action plan received from the terminal device 20.

(5-2. System Modification)

(5-2-1. Determination of Action Plan by Server)

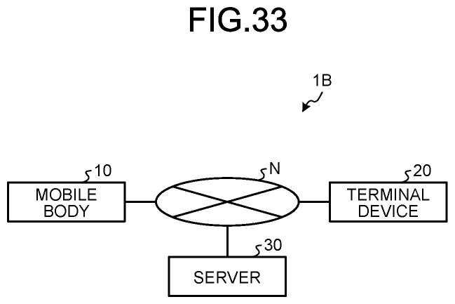

Information processing by the control device 120 according to the embodiment of the present disclosure may be executed by a server. FIG. 33 is a schematic diagram illustrating a system configuration example according to a modification.

As illustrated in FIG. 33, an information processing system 1B according to the modification includes a mobile body 10, a terminal device 20, and a server 30. The configuration of the information processing system 1B is not particularly limited to the example illustrated in FIG. 33, and may include more mobile bodies 10, terminal devices 20, and server devices 300 than those illustrated in FIG. 33.

The mobile body 10, the terminal device 20, and the server 30 are each connected to a network N. The mobile body 10 communicates with the terminal device 20 and the server 30 via the network N. The terminal device 20 communicates with the mobile body 10 and the server 30 via the network N. The server 30 communicates with the mobile body 10 and the terminal device 20 via the network N.

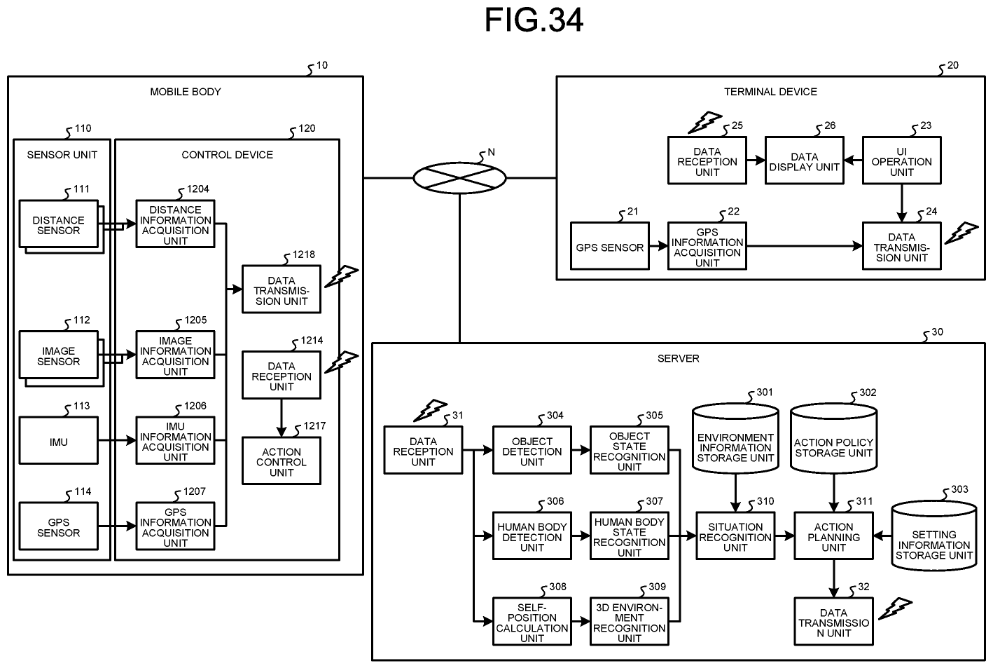

FIG. 34 is a block diagram illustrating a device configuration example according to the modification. The terminal device 20 illustrated in FIG. 34 has a functional configuration similar to the configuration of the terminal device 20 illustrated in FIG. 27. For example, the data transmission unit 24 of the terminal device 20 transmits information such as GPS information acquired from the GPS acquisition unit, player information, and action policy information, to the mobile body 10.

In addition, the control device 120 included in the mobile body 10 illustrated in FIG. 34 has a functional configuration similar to the configuration of the control device 120 illustrated in FIG. 32. The data transmission unit 1218 of the control device 120 transmits, to the server 30, the distance information acquired by the distance information acquisition unit 1204, the image information acquired by the image information acquisition unit 1205, the IMU information acquired by the IMU information acquisition unit 1206, and the GPS information acquired by the GPS information acquisition unit 1207. In addition, the data transmission unit 1218 transmits information such as GPS information, player information, and action policy information received from the terminal device 20, to the server 30.

Furthermore, as illustrated in FIG. 34, the server 30 includes a data reception unit 31 and a data transmission unit 32. The data reception unit 31 has a function similar to the function of the data reception unit 25 of the terminal device 20 illustrated in FIG. 32, for example. The data reception unit 31 receives the distance information, the image information, the IMU information, and the GPS information from the mobile body 10. In addition, the data reception unit 31 receives, from the mobile body 10, GPS information of the terminal device 20, player information of the user of the terminal device 20, and action policy information designated by the user of the terminal device 20.

The data transmission unit 32 has a function similar to the function of the data transmission unit 24 of the terminal device 20 illustrated in FIG. 32. The data transmission unit 32 transmits the action plan determined by an action planning unit 311 to be described below to the mobile body 10.

As illustrated in FIG. 34, the server 30 includes an environment information storage unit 301, an action policy storage unit 302, and a setting information storage unit 303. The environment information storage unit 301 corresponds to the environment information storage unit 1201 illustrated in FIG. 9. The action policy storage unit 302 corresponds to the action policy storage unit 1202 illustrated in FIG. 9. The setting information storage unit 303 corresponds to the setting information storage unit 1203 illustrated in FIG. 9.

Furthermore, as illustrated in FIG. 34, the server 30 includes an object detection unit 304, an object state recognition unit 305, a human body detection unit 306, a human body state recognition unit 307, a self-position calculation unit 308, and a 3D environment recognition unit 309. The object detection unit 304 corresponds to the object detection unit 1208 illustrated in FIG. 9. The object state recognition unit 305 corresponds to the object state recognition unit 1209 illustrated in FIG. 9. The human body detection unit 306 corresponds to the human body detection unit 1210 illustrated in FIG. 9. The human body state recognition unit 307 corresponds to the human body state recognition unit 1211 illustrated in FIG. 9. The self-position calculation unit 308 corresponds to the self-position calculation unit 1212 illustrated in FIG. 9. The 3D environment recognition unit 309 corresponds to the 3D environment recognition unit 1213 illustrated in FIG. 9.

Furthermore, as illustrated in FIG. 34, the server 30 includes a situation recognition unit 310 and an action planning unit 311. The situation recognition unit 310 corresponds to the situation recognition unit 1215 illustrated in FIG. 9. The action planning unit 311 corresponds to the action planning unit 1216 illustrated in FIG. 9.

The situation recognition unit 310 performs processing corresponding to the situation recognition unit 1215. That is, the situation recognition unit 310 recognizes the current situation in preparation for the imaging of the imaging target (such as a player, goods) based on the object recognition result obtained by the object state recognition unit 305, the human body recognition result obtained by the human body state recognition unit 307, the environmental map created by the 3D environment recognition unit 309, the imaging environment information stored in the environment information storage unit 301, and the information received by the data reception unit 31. The situation recognition unit 310 transmits the processing result to the action planning unit 311.

The action planning unit 311 performs processing corresponding to the action planning unit 1216. That is, the action planning unit 311 determines an action plan of the mobile body 10 based on the situation recognition result obtained by the situation recognition unit 310 and the setting information stored in the setting information storage unit 303. The action planning unit 311 transmits the determined action plan to the data transmission unit 32.

(5-2-2. Introduction of External Observation Device)

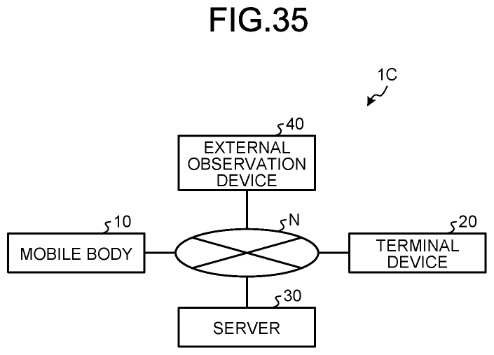

It is also allowable to introduce an external observation device 40, a device of measuring the position of an object, into the information processing system 1B described above. FIG. 35 is a schematic diagram illustrating a system configuration example according to a modification.

As illustrated in FIG. 35, an information processing system 1C according to the modification includes a mobile body 10, a terminal device 20, a server 30, and an external observation device 40. With the external observation device 40 introduced into the information processing system 1C, a part of the processing of the server 30 can be distributed to the external observation device 40. The configuration of the information processing system 1C is not particularly limited in the example illustrated in FIG. 35, and may include more mobile bodies 10, terminal devices 20, servers 30, and external observation devices 40 than those illustrated in FIG. 35.

The mobile body 10, the terminal device 20, the server 30, and the external observation device 40 are each connected to the network N. The mobile body 10 communicates with the terminal device 20 and the server 30 via the network N. The terminal device 20 communicates with the mobile body 10 and the server 30 via the network N. The server 30 communicates with the mobile body 10, the terminal device 20, and the external observation device 40 via the network N. The external observation device 40 communicates with the server 30 via the network N.

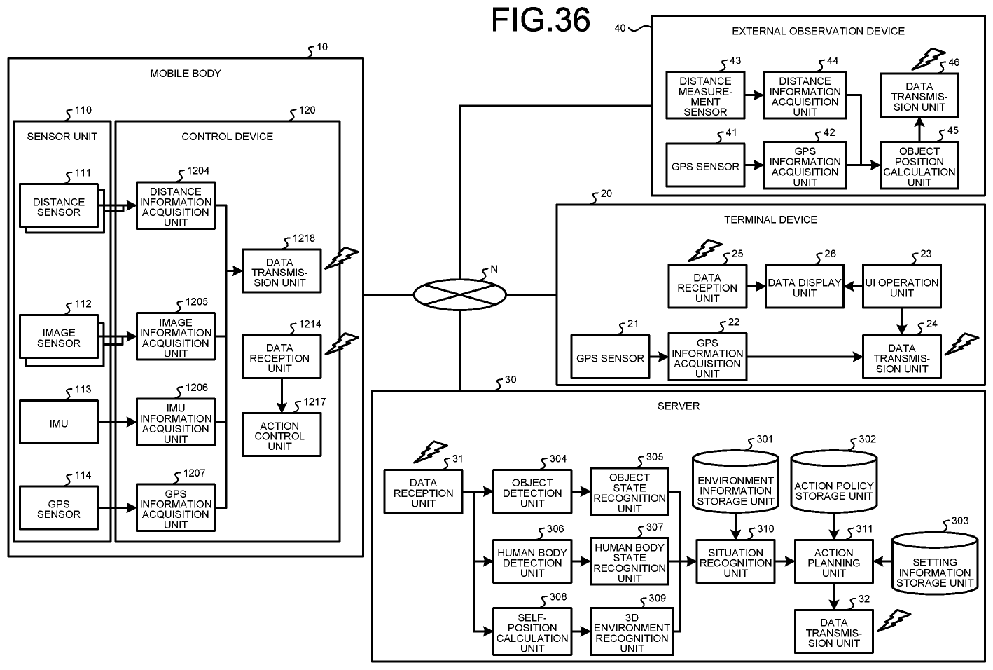

FIG. 36 is a block diagram illustrating a device configuration example according to a modification. The terminal device 20 illustrated in FIG. 36 has a functional configuration similar to the configuration of the terminal device 20 illustrated in FIG. 34. In addition, the control device 120 included in the mobile body 10 illustrated in FIG. 36 has a functional configuration similar to the configuration of the control device 120 illustrated in FIG. 34. In addition, the server 30 illustrated in FIG. 36 has a functional configuration similar to the configuration of the server 30 illustrated in FIG. 34.

Furthermore, the external observation device 40 illustrated in FIG. 36 includes a GPS sensor 41, a GPS information acquisition unit 42, a distance measurement sensor 43, a distance information acquisition unit 44, an object position calculation unit 45, and a data transmission unit 46.

The GPS sensor 41 acquires GPS information. The GPS information acquisition unit 42 acquires GPS information from the GPS sensor 41. The GPS information acquisition unit 42 transmits the GPS information to the object position calculation unit 45.

The distance measurement sensor 43 measures a distance to an object. The distance measurement sensor 43 transmits distance information to the object to the distance information acquisition unit 44. The distance information acquisition unit 44 acquires distance information to an object from the distance measurement sensor 43. The distance information acquisition unit 44 transmits the distance information to the object to the object position calculation unit 45.

The object position calculation unit 45 calculates the object position based on the GPS information acquired from the GPS information acquisition unit 42 and the distance information acquired from the distance information acquisition unit 44. The object position calculation unit 45 transmits the calculated position information of the object to the data transmission unit 46. The data transmission unit 46 transmits the position information of the object to the server 30. For example, when installed in a golf course and having a golf ball set as an observation target, the external observation device 40 can calculate the position of the golf ball hit by the player and transmit the calculated position to the server 30.

(5-3. Team Sports)

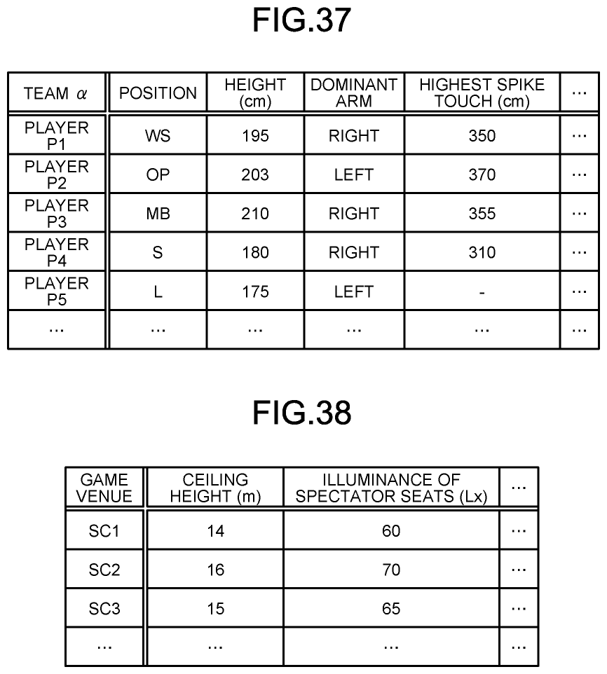

In the above embodiment, the control device 120 can also control the mobile body 10 to execute video recording of a game pattern of a team sport. FIG. 37 is a diagram illustrating an example of player information according to a modification. FIG. 38 is a diagram illustrating an example of imaging environment information according to the modification. The following is an example in which the team sport is volleyball.

When causing the mobile body 10 to execute video recording of a volleyball game pattern, the control device 120 acquires, for each team that performs the volleyball game, a variety of information related to an associated player of the team, as player information. FIG. 37 illustrates an information example of a player belonging to a team a playing a volleyball game, for example. As illustrated in FIG. 37, examples of the player information include information, specifically, a position such as a wing spiker (WS) or an opposite (OP), a height, and a highest spike touch.

Furthermore, as illustrated in FIG. 38, the control device 120 acquires information regarding a game venue where a volleyball game is played, as imaging environment information. Examples of the imaging environment information include information such as the height of the ceiling of the venue where the volleyball game is played and the illuminance of the spectator seats.

Furthermore, similarly to the above embodiment, the control device 120 determines an action plan for controlling the mobile body 10 to execute the video recording of the volleyball game pattern based on the situation recognition result of the player who is playing volleyball and the setting information predefined for volleyball. For example, when having recognized a situation in which a server tries to perform a jump serve, the control device 120 determines the camera angle based on player information such as the height, dominant arm, and highest spike touch of the player, and action constraint conditions such as the height of the ceiling of the venue. The control device 120 controls to move the mobile body 10 to an appropriate imaging position and determines an action plan for imaging the moment of the jump serve before the corresponding player performs the jump serve. The control device 120 controls the operation of the mobile body 10 so as to act following the determined action plan. In this manner, even in a case where the video recording target is a team sport, the control device 120 can record appropriate information corresponding to the type of sport.

(5-4. Video Recording Other than Sports)

Although the above embodiment is an example in which the control device 120 records appropriate information corresponding to the type of sport, the present technology can also be applied to a case where video recording is performed on an imaging target other than sports. For example, by adjusting the setting information for determining the action plan of the mobile body 10, it is possible to record information reflecting the user's intention or request with respect to the imaging target other than sports.

### 6. Others

The control device 120, the terminal device 20, and the server 30 according to the embodiment and the modifications of the present disclosure may be implemented by a dedicated computer system or a general-purpose computer system.

In addition, various programs for implementing the information processing method executed by the control device 120, the terminal device 20, and the server 30 according to the embodiment and the modifications of the present disclosure may be stored and distributed in a computer-readable recording medium such as an optical disk, semiconductor memory, a magnetic tape, or a flexible disk. At this time, the control device 120, the terminal device 20, and the server 30 according to the embodiment and the modifications of the present disclosure can implement the information processing method according to the embodiment and the modifications of the present disclosure by installing various programs in a computer and executing the programs.

In addition, various programs for implementing the information processing method executed by the control device 120, the terminal device 20, and the server 30 according to the embodiment and the modification of the present disclosure may be stored in a disk device included in a server on a network such as the Internet and may be downloaded to a computer. In addition, functions provided by various programs for implementing the information processing method executed by the control device 120, the terminal device 20, and the server 30 according to the embodiment and the modifications of the present disclosure may be implemented by cooperative operations of the OS and the application program. In this case, the sections other than the OS may be stored in a medium for distribution, or the sections other than the OS may be stored in an application server so as to be downloaded to a computer, for example.

Furthermore, among individual processing described in the above embodiments and modifications of the present disclosure, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, a variety of information illustrated in each of the drawings are not limited to the information illustrated.

In addition, the components of the control device 120, the terminal device 20, and the server 30 according to the embodiment and the modifications of the present disclosure are functionally conceptual, and do not necessarily need to be physically configured as illustrated in the drawings. That is, the specific form of distribution/integration of each of the devices is not limited to those illustrated in the drawings, and all or a part thereof may be functionally or physically distributed or integrated into arbitrary units according to various loads and use situations.

Furthermore, the above-described embodiments and modifications of the present disclosure can be appropriately combined within a range implementable without contradiction of processes. Furthermore, the order of individual steps illustrated in the flowcharts of the above-described embodiments of the present disclosure can be changed as appropriate.

### 7. Hardware Configuration Example

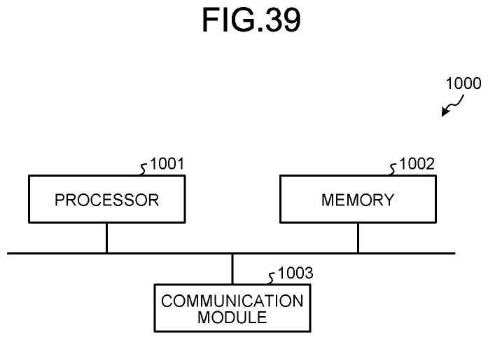

A hardware configuration example of a computer capable of implementing the control device 120 according to the embodiment of the present disclosure will be described with reference to FIG. 39. FIG. 39 is a block diagram illustrating a hardware configuration example of a computer capable of implementing the control device according to the embodiment of the present disclosure. Note that FIG. 39 illustrates an example of a computer, and is not necessarily limited to the configuration illustrated in FIG. 39.

As illustrated in FIG. 39, the control device 120 according to the embodiment of the present disclosure can be implemented by a computer 1000 including a processor 1001, memory 1002, and a communication module 1003, for example.

The processor 1001 is typically a central processing unit (CPU), a digital signal processor (DSP), a system-on-a-chip (SoC), a system large scale integration (LSI), or the like.

The memory 1002 is typically nonvolatile or volatile semiconductor memory such as random access memory (RAN), read only memory (ROM) or flash memory, or a magnetic disk. The environment information storage unit 1201, the action policy storage unit 1202, and the setting information storage unit 1203 included in the control device 120 are implemented by the memory 1002.

The communication module 1003 is typically a module such as a communication card for wired or wireless local area network (LAN), long term evolution (LTE), Bluetooth (registered trademark), wireless USB (WUSB), a router for optical communication, or various communication modems. The functions of the data reception unit 1214 and the data transmission unit 1218 included in the control device 120 according to the above embodiment are implemented by the communication module 1003.

The processor 1001 functions as an arithmetic processing device or a control device, for example, and controls all or part of operations of each component based on various programs recorded in the memory 1002. Each functional unit (the distance information acquisition unit 1204, the image information acquisition unit 1205, the IMU information acquisition unit 1206, the GPS information acquisition unit 1207, an object detection unit 1208, the object state recognition unit 1209, the human body detection unit 1210, the human body state recognition unit 1211, the self-position calculation unit 1212, the 3D environment recognition unit 1213, the data reception unit 1214, the situation recognition unit 1215, the action planning unit 1216, the action control unit 1217, and the data transmission unit 1218) included in the control device 120 is implemented by the processor 1001 reading a control program in which a command for operating as each functional unit is described from the memory 1002 and executing the control program.

That is, the processor 1001 and the memory 1002 implement information processing by each functional unit included in the control device 120 in cooperation with software (control program stored in the memory 1002).

### 8. Conclusion

The control device according to the embodiment of the present disclosure includes the first recognition unit, the second recognition unit, the third recognition unit, and the planning unit. The first recognition unit recognizes the state of the imaging target of the mobile body based on information acquired by the sensor. The second recognition unit recognizes a surrounding environment of the mobile body based on information acquired by the sensor. The third recognition unit recognizes the current situation in preparation for the imaging of the imaging target based on the recognition result of the state of the imaging target obtained by the first recognition unit, the recognition result of the surrounding environment obtained by the second recognition unit, and the imaging environment information regarding the imaging environment in which the imaging of the imaging target is performed. The planning unit determines an action plan of the mobile body for executing video recording of the imaging target based on a situation recognition result, obtained by the third recognition unit and indicating a recognition result of a current situation in preparation for imaging of the imaging target and based on setting information predefined for each type of sport for determining the operation of the mobile body. This makes it possible for the control device 120 to record appropriate information according to the type of sport.

In addition, the above-described setting information predefines an action constraint condition of the mobile body including: information (player information) specific to the player related to the type of sport; information (player motion information) on the motion detail of the player related to the classification of the sport; information regarding the surrounding environment of the mobile body; and imaging environment information, and also predefines an specific action corresponding to the action constraint condition. This makes it possible to prepare an appropriate action plan for performing video recording reflecting predefined specific actions in accordance with the personality of the player, the surrounding environment of the mobile body, the imaging environment, and the like.

In addition, the setting information described above includes the remaining power accumulated in the mobile body in the action constraint condition. The planning unit determines an action plan based on the remaining power accumulated in the mobile body. This makes it possible to maximize the continuation the video recording by the mobile body.

The imaging target includes a player of a sport and goods used by the player. The above-described imaging environment information includes information regarding a place where a sport is played. The third recognition unit recognizes the current situation in preparation for the imaging of the imaging target based on the state of the player, the state of the goods, and the information regarding the place where the sport is performed. This makes it possible to prepare an action plan for implementing the video recording according to the positional relationship between the player and the goods and the place where the sport is played.

Furthermore, the planning unit determines presentation of information useful for the player to proceed with the sport, as a part of the action plan. This makes it possible to improve the usability of the user who performs video recording using the mobile body.

In addition, the planning unit described above determines, as a part of the action plan, execution of a motion useful for the player to proceed with a sport. This makes it possible to further improve the usability of the user who performs video recording using the mobile body.

Furthermore, the above-described third recognition unit recognizes a current situation in preparation for imaging of the imaging target based on a recognition result of the state of the imaging target acquired from another control device. This makes it possible for the control device to distribute the processing load of the information processing for executing the video recording.

Furthermore, the planning unit described above determines execution of imaging of the imaging target without flying, as a part of the action plan. This makes it possible to minimize the power consumption of the mobile body.

Furthermore, the above-described control device further includes a transmission unit that transmits, at a predetermined timing, image information recorded by video recording to a terminal device possessed by the user who is an imaging target. This makes it possible to provide the recorded image information to the user at any timing.

The embodiments and their modifications of the present disclosure have been described above. However, the technical scope of the present disclosure is not limited to the above-described embodiments or their modifications and various modifications can be made without departing from the scope of the present disclosure. Moreover, it is allowable to combine the components across different embodiments and modifications as appropriate.

Furthermore, the effects described in the present specification are merely illustrative or exemplary and are not limited. That is, the technology according to the present disclosure can exhibit other effects that are apparent to those skilled in the art from the description of the present specification in addition to or instead of the above effects.

Note that the technology of the present disclosure can also have the following configurations as belonging to the technical scope of the present disclosure.

(1)

A control device comprising:
a first recognition unit that recognizes a state of an imaging target of a mobile body based on information acquired by a sensor;
a second recognition unit that recognizes a surrounding environment of the mobile body based on information acquired by the sensor;
a third recognition unit that recognizes a current situation in preparation for imaging of the imaging target based on a recognition result of the state of the imaging target obtained by the first recognition unit, a recognition result of the surrounding environment obtained by the second recognition unit, and imaging environment information regarding an imaging environment in which the imaging of the imaging target is performed; and
a planning unit that determines an action plan of the mobile body for executing video recording of the imaging target based on a situation recognition result indicating the recognition result of the current situation in preparation for imaging of the imaging target obtained by the third recognition unit and based on setting information predefined for each type of sport for determining an operation of the mobile body.

(2)

The control device according to (1),
wherein the third recognition unit performs
recognition based on at least one of information specific to a player related to a type of the sport, information regarding a motion detail of the player related to the type of the sport, information regarding a surrounding environment of the mobile body, and the imaging environment information, as the current situation in preparation for imaging of the imaging target.

(3)

The control device according to (2),
wherein the third recognition unit recognizes
the current situation in preparation for imaging of the imaging target based on information regarding a remaining power level of the mobile body.

(4)

The control device according to (2) or (3),
wherein the setting information is
constituted by associating information specifying the type of the sport, information designating a specific action of the mobile body, and information regarding the specific action of the mobile body with each other.

(5)

The control device according to any one of (2 to (4),
wherein the planning unit determines
presentation of information useful for the player to proceed with the sport, as a part of the action plan.

(6)

The control device according to any one of (2) to (5),
wherein the planning unit determines
execution of a motion useful for the player to proceed with the sport, as a part of the action plan.

(7)

The control device according to (1),
wherein the third recognition unit recognizes
the current situation in preparation for imaging of the imaging target based on the situation recognition result acquired from another control device.

(8)

The control device according to any one of (1) to (7),
wherein the planning unit determines
to capture an image of an imaging target without moving, as a part of the action plan.

(9)

The control device according to any one of (1) to (8), further comprising
a transmission unit that transmits, at a predetermined timing, image information recorded by the video recording to a terminal device possessed by a user being the imaging target.

(10)

A control method performed by a processor, the method comprising:
recognizing a state of an imaging target of a mobile body based on information acquired by a sensor;
recognizing a surrounding environment of the mobile body based on information acquired by the sensor;
recognizing a current situation in preparation for imaging of the imaging target based on a recognition result of the state of the imaging target, a recognition result of the surrounding environment, and imaging environment information regarding an imaging environment in which the imaging of the imaging target is performed; and
determining an action plan of the mobile body for executing video recording of the imaging target based on a situation recognition result indicating the recognition result of the current situation in preparation for imaging of the imaging target and based on setting information predefined for each type of sport for determining an operation of the mobile body.

### REFERENCE SIGNS LIST

1A, 1B, 1C INFORMATION PROCESSING SYSTEM
10 MOBILE BODY
20 TERMINAL DEVICE
21, 41, 114 GPS SENSOR
22, 42, 1207 GPS INFORMATION ACQUISITION UNIT
23 UI OPERATION UNIT
24, 32, 46, 1218 DATA TRANSMISSION UNIT
25, 31, 1214 DATA RECEPTION UNIT
26 DATA DISPLAY UNIT
30 SERVER
40 EXTERNAL OBSERVATION DEVICE
43 DISTANCE MEASUREMENT SENSOR
44, 1204 DISTANCE INFORMATION ACQUISITION UNIT
45 OBJECT POSITION CALCULATION UNIT
111 DISTANCE SENSOR
112 IMAGE SENSOR
113 IMU
201, 301, 1201 ENVIRONMENT INFORMATION STORAGE UNIT
202, 302, 1202 ACTION POLICY STORAGE UNIT
203, 303, 1203 SETTING INFORMATION STORAGE UNIT
204, 304, 1208 OBJECT DETECTION UNIT
205, 305, 1209 OBJECT STATE RECOGNITION UNIT
206, 306, 1210 HUMAN BODY DETECTION UNIT
207, 307, 1211 HUMAN BODY STATE RECOGNITION UNIT
208, 308, 1212 SELF-POSITION CALCULATION UNIT
209, 309, 1213 3D ENVIRONMENT RECOGNITION UNIT
210, 310, 1215 SITUATION RECOGNITION UNIT
211, 311, 1216 ACTION PLANNING UNIT
1205 IMAGE INFORMATION ACQUISITION UNIT
1206 IMU INFORMATION ACQUISITION UNIT
1217 ACTION CONTROL UNIT

1. A control device comprising:
a first recognition unit that recognizes a state of an imaging target of a mobile body based on information acquired by a sensor;
a second recognition unit that recognizes a surrounding environment of the mobile body based on information acquired by the sensor;
a third recognition unit that recognizes a current situation in preparation for imaging of the imaging target based on a recognition result of the state of the imaging target obtained by the first recognition unit, a recognition result of the surrounding environment obtained by the second recognition unit, and imaging environment information regarding an imaging environment in which the imaging of the imaging target is performed; and
a planning unit that determines an action plan of the mobile body for executing video recording of the imaging target based on a situation recognition result indicating the recognition result of the current situation in preparation for imaging of the imaging target obtained by the third recognition unit and based on setting information predefined for each type of sport for determining an operation of the mobile body.

2. The control device according to claim 1,
wherein the third recognition unit performs
recognition based on at least one of information specific to a player related to a type of the sport, information regarding a motion detail of the player related to the type of the sport, information regarding a surrounding environment of the mobile body, and the imaging environment information, as the current situation in preparation for imaging of the imaging target.

3. The control device according to claim 2,
wherein the third recognition unit recognizes
the current situation in preparation for imaging of the imaging target based on information regarding a remaining power level of the mobile body.

4. The control device according to claim 1,
wherein the setting information is
constituted by associating information specifying the type of the sport, information designating a specific action of the mobile body, and information regarding the specific action of the mobile body with each other.

5. The control device according to claim 2,
wherein the planning unit determines
presentation of information useful for the player to proceed with the sport, as a part of the action plan.

6. The control device according to claim 2,
wherein the planning unit determines
execution of a motion useful for the player to proceed with the sport, as a part of the action plan.

7. The control device according to claim 1,
wherein the third recognition unit recognizes
the current situation in preparation for imaging of the imaging target based on the situation recognition result acquired from another control device.

8. The control device according to claim 1,
wherein the planning unit determines
to capture an image of an imaging target without moving, as a part of the action plan.

9. The control device according to claim 1, further comprising
a transmission unit that transmits, at a predetermined timing, image information recorded by the video recording to a terminal device possessed by a user being the imaging target.

10. A control method performed by a processor, the method comprising:
recognizing a state of an imaging target of a mobile body based on information acquired by a sensor;
recognizing a surrounding environment of the mobile body based on information acquired by the sensor;
recognizing a current situation in preparation for imaging of the imaging target based on a recognition result of the state of the imaging target, a recognition result of the surrounding environment, and imaging environment information regarding an imaging environment in which the imaging of the imaging target is performed; and
determining an action plan of the mobile body for executing video recording of the imaging target based on a situation recognition result indicating the recognition result of the current situation in preparation for imaging of the imaging target and based on setting information predefined for each type of sport for determining an operation of the mobile body.
